(19) United States
(12) Patent Application Publication
(10) Pub. No.: US 2025/0199259 A1
(43) Pub. Date: Jun. 19, 2025

(54) FIBER DISTRIBUTION POINT STRUCTURALLY CONFIGURED TO PERMIT ENHANCED ACCESS TO THE FIBER DISTRIBUTION POINT AND TO PERMIT MINIMIZING A SIZE OF AN UNDERGROUND CLOSURE

(71) Applicant: PPC BROADBAND, INC., East Syracuse, NY (US)

(72) Inventors: Sreekumar PONNATH, Palakkad (KL) (IN); Afzal V. ABDULSALAM, Edathala (KL) (IN); Syed Azhar ALI HUSSAINI, Riyadh (SA)

(73) Assignee: PPC BROADBAND, INC., East Syracuse, NY (US)

(21) Appl. No.: 18/988,804

(22) Filed: Dec. 19, 2024

Related U.S. Application Data
(60) Provisional application No. 63/718,097, filed on Nov. 8, 2024.

(30) Foreign Application Priority Data
Dec. 19, 2023 (IN) 202311086840

(51) Int. Cl. G02B 6/44

(52) U.S. Cl. CPC G02B 6/44526; G02B 6/44528; G02B 6/4454

(57) ABSTRACT

A fiber distribution point structurally configured to minimize an interior space of a closure required to receive the fiber distribution point and to provide enhanced access to the fiber distribution point. The fiber distribution point may include a fiber management portion, a first mounting portion configured to pivot the fiber management portion between a first position and a second position, a second mounting portion configured to move the fiber management portion between the second position and a third position which is distal from the pivot axis, and, a third mounting portion configured to allow rotation of the fiber management portion about an axis of rotation.

### CROSS-REFERENCE TO RELATED APPLICATIONS

This application claims priority to Indian Provisional Patent Application No. 202311086840, filed Dec. 19, 2023, and U.S. Provisional Patent Application No. 63/718,097, filed Nov. 8, 2024, the entire disclosures of which are incorporated herein by reference.

### TECHNICAL FIELD

The present disclosure relates generally to fiber distribution point systems, and more particularly to compact, high-capacity fiber distribution point systems.

### BACKGROUND

As the demand for telecommunications increases, fiber optic networks are being extended in more and more areas. Conventionally, FTTdp (fiber-to-the-distribution-point) refers to moving the end of the fiber optic cables to close to the boundary of the customer's premises in the last possible junction box or cabinet, known as the “distribution point.” At the distribution point, the fiber optic cables can be spliced, split, patched, or terminated as needed. Conventionally, the fiber distribution point is housed in an external cabinet attached to the premises or other nearby structure. Space constraints can make conveniently locating the cabinet and providing easy access to the installed cabinet challenging.

Therefore, it may be desirable to provide a fiber distribution point that is structurally configured to be pivotally and slidingly mounted to an underground closure so as to permit enhanced access to splicing, patching, and splitting portions of the fiber distribution point. It may be desirable to provide a fiber distribution point that is structurally configured to permit minimizing a size of the underground closure so as to reduce a ground level footprint of the closure.

### SUMMARY

The present disclosure provides a fiber distribution point system configured to be compact, to accommodate a high density of fibers, and to provide easy access for a technician to work on the fiber distribution point system. In some embodiments, the fiber distribution point may be structurally configured to minimize an interior space of a closure required to receive the fiber distribution point and to provide enhanced access to the fiber distribution point.

In some embodiments, the fiber distribution point system may include a fiber management portion and one or more mounting portions. In some embodiments, the fiber management portion may be structurally configured to include a splicing portion, a patching portion, and a splitting portion.

In some embodiments, the fiber distribution point system may include a first mounting portion structurally configured to pivotally couple the fiber management portion with a closure, a second mounting portion structurally configured to slidingly couple the fiber management portion with the first mounting portion, and a third mounting portion structurally configured to rotatingly couple the fiber management portion with the second mounting portion.

In some embodiments, the first mounting portion may include a body portion structurally configured to pivot the fiber management portion between a first position and a second position. In some embodiments, the first mounting portion may include a first locking portion that is structurally configured to lock the body portion in the second position.

In some embodiments, the second mounting portion may include a translating portion structurally configured to move axially along a length of the body portion to move the fiber management portion between the second position which is proximal to a pivot axis of the body portion and a third position which is distal from the pivot axis. In some embodiments, the second mounting portion may include a second locking portion that is structurally configured to releasingly couple the translation portion to the body portion.

In some embodiments, the fiber distribution point may include a first support portion structurally configured to support the fiber management portion in the first position by engaging a distal end portion of the fiber management portion.

In some embodiments, the fiber distribution point may include a second support portion structurally configured to support the fiber management portion in the third position by engaging a distal end portion of the first mounting portion. In some embodiments, the second support portion may be structurally configured to pivot between a stored position in which second support portion is configured to be received within an interior space of the closure and an extended position, where the second support portion extends out of the interior space.

In some embodiments, the fiber management portion may be structurally configured to be rotatingly coupled with an attachment portion of the third mounting portion. In some embodiments, the third mounting portion may include a third locking mechanism that is structurally configured to couple the attachment portion with the second mounting portion. In some embodiments, the third mounting portion may be structurally configured to allow rotation of the fiber management portion about an axis of rotation.

In some embodiments, the fiber management portion may include a fourth locking mechanism that is structurally configured to lock the fiber management portion at various degrees of rotation about the axis of rotation.

In some embodiments, the fiber management portion may include a frame portion structurally configured to support the splicing portion, the patching portion, and the splitting portion. In some embodiments, the frame portion may include a front side portion and a rear side portion, and wherein the rear side portion may include a panel portion structurally configured to pivot outward. In some embodiments, the splicing portion may be structurally configured to attach to an inner face of the panel portion.

In some embodiments, the splicing portion may include a splice holder portion structurally configured to attach to a splice holder base portion. In some embodiments, the splice holder portion may be structurally configured to pivot relative to the splice holder base portion.

In some embodiments, the patching portion may include a plurality of fiber input ports and a plurality of fiber output ports. In some embodiments, the patching portion may be structurally configured to attach to the front side portion of the frame portion.

In some embodiments, the splitting portion may be configured to split an input fiber into multiple output fibers. In some embodiments, the splitting portion may be structurally configured to attach to a top side portion of the frame portion.

In some embodiments, the fiber management portion may be structurally configured to provide a pass-through route for a communication cable to be routed through the fiber management portion without interacting with the splicing portion, patching portion, or splitting portion. In some embodiments, the pass-through route may include a cable management portion attached to an outer face of the panel portion.

In some embodiments, the second mounting portion may include a translating portion structurally configured to slidingly move relative to the body portion along a length of the body portion.

In some embodiments, the body portion may be structurally configured to be disposed at the first position such that the fiber distribution point is structurally configured to minimize an interior space of a closure required to receive the fiber distribution point so as to reduce a ground level footprint of the closure.

In some embodiments, the first mounting portion, the second mounting portion, and the third mounting portion may be structurally configured to move the fiber distribution point relative to the closure so as to provide enhanced access to the splicing portion, the patching portion, and the splitting portion.

In some embodiments, the closure may have an internal volume of less than 30,000 cm³.

In some embodiments, the patching portion may have 144 or more fiber output ports. In some embodiments, the splitting portion may be configured to provide 128 splitter output ports.

In some embodiments, the fiber distribution point may include a fiber management portion having a splicing portion, a patching portion, a splitting portion, and a frame portion structurally configured to support the splicing portion, the patching portion, and the splitting portion.

In some embodiments, the fiber distribution point may include first mounting portion having a body portion structurally configured to couple the fiber management portion with a closure and to pivot the fiber management portion between a first position and a second position.

In some embodiments, the fiber distribution point may include a second mounting portion having a translating portion structurally configured to couple the fiber management portion with the first mounting portion and to move axially along a length of the body portion to move the fiber management portion between the second position which is proximal to a pivot axis of the body portion and a third position which is distal from the pivot axis.

In some embodiments, the fiber distribution point may include a third mounting portion structurally configured to couple the fiber management portion with the second mounting portion and allow rotation of the fiber management portion about an axis of rotation

In some embodiments, the fiber distribution point may include a first support portion structurally configured to support the fiber management portion in the first position by engaging a distal end portion of the fiber management portion.

In some embodiments, the fiber distribution point may include a second support portion structurally configured to support the fiber management portion in the third position by engaging a distal end portion of the first mounting portion.

In some embodiments, the second support portion may be structurally configured to pivot between a stored position in which second support portion is configured to be received within an interior space of the closure and an extended position, where the second support portion extends out of the interior space.

In some embodiments, the fiber management portion may include a rotation locking mechanism that is structurally configured to lock the fiber management portion at various degrees of rotation about the axis of rotation.

In some embodiments the frame portion may include a panel portion structurally configured to pivot outward. In some embodiments, the splicing portion may be structurally configured to attach to an inner face of the panel portion.

In some embodiments, the splicing portion may include a splice holder portion structurally configured to attach to and pivot relative to a splice holder base portion.

In some embodiments, the patching portion may include a plurality of fiber input ports and a plurality of fiber output ports.

In some embodiments, the splitting portion may be configured to split an input fiber into multiple output fibers.

In some embodiments, the body portion may be structurally configured to be disposed at the first position such that the fiber distribution point is structurally configured to minimize an interior space of a closure required to receive the fiber distribution point so as to reduce a ground level footprint of the closure.

In some embodiments, the first mounting portion, the second mounting portion, and the third mounting portion may be structurally configured to move the fiber distribution point relative to the closure so as to provide enhanced access to the splicing portion, the patching portion, and the splitting portion.

In some embodiments the first mounting portion may include a first locking portion that is structurally configured to lock the body portion in the second position.

In some embodiments, the second mounting portion may include a second locking portion that is structurally configured to releasingly couple the translation portion to the body portion.

In some embodiments, the fiber management portion may be structurally configured to be rotatingly coupled with an attachment portion of the third mounting portion. In some embodiments, the third mounting portion may include a third locking mechanism that is structurally configured to couple the attachment portion with the second mounting portion.

In some embodiments, the patching portion may be structurally configured to attach to a front side of the frame portion. In some embodiments, the splitting portion may be structurally configured to attach to a top side of the frame portion.

In some embodiments, the fiber management portion may be structurally configured to provide a pass-through route for a communication cable to be routed through the fiber management portion without interacting with the splicing portion, patching portion, or splitting portion, wherein the pass-through route includes a cable management portion attached to an outer face of the panel portion.

In some embodiments, a fiber management portion may include a splicing portion, a patching portion, a splitting portion, and a frame portion structurally configured support the splicing portion, the patching portion, and the splitting portion.

In some embodiments, a fiber management portion may include a first mounting portion having a body portion structurally configured to couple the fiber management portion with a closure and to pivot the fiber management portion between a first position and a second position

In some embodiments, a fiber management portion may include a second mounting portion having a translating portion structurally configured to couple the fiber management portion with the first mounting portion and to move axially along a length of the body portion to move the fiber management portion between the second position which is proximal to a pivot axis of the body portion and a third position which is distal from the pivot axis.

In some embodiments, a fiber management portion may include a third mounting portion structurally configured to couple the fiber management portion with the second mounting portion and allow rotation of the fiber management portion about an axis of rotation.

In some embodiments, a fiber management portion may include a rotation locking mechanism that is structurally configured to lock the fiber management portion at various degrees of rotation about the axis of rotation.

In some embodiments, the frame portion may include a panel portion structurally configured to pivot outward.

In some embodiments, the splicing portion may be structurally configured to attach to an inner face of the panel portion. In some embodiments, the splicing portion may include a splice holder structurally configured to attach to and pivot relative to a splice holder base portion.

In some embodiments, the patching portion may include a plurality of fiber input ports and a plurality of fiber output ports.

In some embodiments, the splitting portion may be configured to split an input fiber into multiple output fibers.

In some embodiments, the body portion may be structurally configured to be disposed at the first position such that the fiber distribution point is structurally configured to minimize an interior space of a closure required to receive the fiber distribution point so as to reduce a ground level footprint of the closure.

In some embodiments, the first mounting portion, the second mounting portion, and the third mounting portion may be structurally configured to move the fiber distribution point relative to the closure so as to provide enhanced access to the splicing portion, the patching portion, and the splitting portion.

In some embodiments, the first mounting portion may include a first locking portion that is structurally configured to lock the body portion in the second position.

In some embodiments, the second mounting portion may include a second locking portion that is structurally configured to releasingly couple the translation portion to the body portion.

In some embodiments, the fiber management portion may be structurally configured to be rotatingly coupled with an attachment portion of the third mounting portion.

In some embodiments, the third mounting portion may include a third locking mechanism that is structurally configured to couple the attachment portion with the second mounting portion.

In some embodiments, the storage support portion may be structurally configured to support the fiber management portion in the first position by engaging a distal end portion of the fiber management portion.

In some embodiments, the fiber distribution point may include an extension support portion structurally configured to support the fiber management portion in the third position by engaging a distal end portion of the first mounting portion. In some embodiments, the extension support portion may be structurally configured to pivot between a stored position in which extension support portion is configured to be received within an interior space of the closure and an extended position, where the extension support portion extends out of the interior space.

In some embodiments, the patching portion may be structurally configured to attach to a front side of the frame portion and the splitting portion is structurally configured to attach to a top side of the frame portion.

In some embodiments, the fiber management portion may be structurally configured to provide a pass-through route for a communication cable to be routed through the fiber management portion without interacting with the splicing portion, patching portion, or splitting portion, wherein the pass-through route includes a cable management portion attached to an outer face of the panel portion.

In some embodiments, the patching portion may be configured to include 144 or more fiber output ports and the splitting portion may be configured to include 128 splitter output ports.

In some embodiments, the fiber distribution point may include a fiber management portion structurally configured to include a splicing portion, a patching portion, and a splitting portion.

In some embodiments, the fiber distribution point may include a first mounting portion structurally configured to pivotally couple the fiber management portion with a closure.

In some embodiments, the fiber distribution point may include a second mounting portion structurally configured to couple the fiber management portion with the first mounting portion. In some embodiments, the second mounting portion may be structurally configured to allow rotation of the fiber management portion about an axis of rotation relative to the first mounting portion.

In some embodiments, the closure may be structurally configured to be buried in the ground and present a ground level footprint.

In some embodiments, the first mounting portion may include a body portion structurally configured to pivot between a first position, where the fiber management portion is configured to be received within an interior space of the closure, and the second position, where the fiber management portion is exterior to the interior space. In some embodiments, the first mounting portion may be structurally configured to move the fiber distribution point exterior to the closure and extended away from the closure so as to provide enhanced access to the splicing portion, the patching portion, and the splitting portion.

In some embodiments, the fiber distribution point may include may include a first support portion structurally configured to support the fiber management portion in the first position by engaging a distal end portion of the fiber management portion.

In some embodiments, the fiber management portion may include a locking mechanism that is structurally configured to lock the fiber management portion at various degrees of rotation about the axis of rotation.

In some embodiments, the fiber management portion may include a frame portion structurally configured to support the splicing portion, the patching portion, and the splitting portion.

In some embodiments, the frame portion may include a front side and a rear side. In some embodiments, the rear side may include a panel portion structurally configured to pivot outward. In some embodiments, the splicing portion may be structurally configured to attach to an inner face of the pane portion.

In some embodiments, the splicing portion may include a splice holder portion structurally configured to attach to a splice holder base portion. In some embodiments, the splice holder portion may be structurally configured to pivot relative to the splice holder base portion.

In some embodiments, the patching portion may include a plurality of fiber input ports and a plurality of fiber output ports. In some embodiments, the patching portion may be structurally configured to attach to the front side of the frame portion.

In some embodiments, the splitting portion may be configured to split an input fiber into multiple output fibers. In some embodiments, the splitting portion may be structurally configured to attach to a top side of the frame portion.

In some embodiments, the fiber management portion may be structurally configured to provide a pass-through route for a communication cable to be routed through the fiber management portion without interacting with the splicing portion, patching portion, or splitting portion, wherein the pass-through route includes a cable management portion attached to an outer face of the panel portion.

In some embodiments, a vault distribution point may include any of the fiber distribution points disclosed herein and a closure structurally configured to be buried in the ground and present a ground level footprint. In some embodiments, a body portion may be configured to pivot between the first position, where the fiber management portion is configured to be received within an interior space of the closure, and the second position, where the fiber management portion is exterior to the interior space.

In some embodiments, the first mounting portion, the second mounting portion, and the third mounting portion may be structurally configured to move the fiber distribution point exterior to the closure and extended away from the closure so as to provide enhanced access to the splicing portion, the patching portion, and the splitting portion.

In some embodiments, the translating portion may be structurally configured to be coupled at the proximal position of the body portion and the body portion may be structurally configured to be disposed at the first position such that the fiber distribution point is structurally configured to minimize an interior space of the closure so as to reduce a ground level footprint of the closure.

In some embodiments, the first mounting portion may be structurally configured such that the body portion extends in a direction from a first corner toward a second corner.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a perspective view of an example distribution point system in accordance with various aspects of the disclosure with a distribution point in a first position.

FIG. 2 is a side section view of the system of FIG. 1.

FIG. 3 is a perspective view of the system of FIG. 1 installed underground.

FIG. 4 is a perspective view of the system of FIG. 1 with the distribution point shown in a second position.

FIG. 5 is top view of an example first mounting portion of the system of FIG. 1.

FIG. 6 is a perspective view of an example locking mechanism for the first mounting portion of FIG. 8.

FIG. 7 is a perspective view of the system of FIG. 1 with the distribution point shown in a third position.

FIG. 8 is a side view of the distribution point in the third position.

FIG. 9 is a perspective view of an example second mounting portion of the system of FIG. 1.

FIG. 10 is a perspective view of the second mounting portion with the distribution point detached.

FIG. 11 is a perspective view of the second mounting portion with the distribution point attached.

FIG. 12 is a perspective view of the system of FIG. 7 with a cover removed from the distribution point.

FIG. 13 is an exploded view of an example third mounting portion of the system of FIG. 1.

FIG. 14 is an exploded view of an example distribution point of the system of FIG. 1.

FIG. 15 is a perspective view of the distribution point of FIG. 14 with a splice holder in an open position.

FIG. 16 is a side view of another example of a locking mechanism for the first mounting portion.

FIG. 17 is a side view of the locking mechanism of FIG. 15 in a first position.

FIG. 18 is a side view of the locking mechanism of FIG. 16 in a second position.

FIG. 19 is a perspective view of an example distribution point system in accordance with various aspects of the disclosure with a distribution point in a first position and installed underground.

FIG. 20 is a side section view of the system of FIG. 19.

FIG. 21 is a perspective view of the system of FIG. 19 with the distribution point shown in a second position.

FIG. 22 is an enlarged perspective view of the system of FIG. 21 showing a support portion.

FIG. 23 is a front perspective view of an example first mounting portion of the system of FIG. 19 showing locking mechanisms.

FIG. 24 is a side perspective view of first mounting portion of FIG. 24.

FIG. 25 is a perspective view of the system of FIG. 19 with the distribution point shown in a third position.

FIG. 26 is a perspective view of an example second mounting portion of the system of FIG. 19 with the distribution point detached.

FIG. 27 is an exploded view of an example third mounting portion of the system of FIG. 19.

FIG. 28 is an exploded view of an example distribution point of the system of FIG. 19.

FIG. 29 is a perspective view of the distribution point of FIG. 28 with a splice holder in an open position.

FIG. 30 is a perspective view of an example distribution point system in accordance with various aspects of the disclosure with a distribution point in a first position and installed underground.

FIG. 31 is a side section view of the system of FIG. 30.

FIG. 32 is a perspective view of the system of FIG. 30 in a second position.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Embodiments of the disclosure provide a fiber distribution point system 10, for example, a vault distribution point, that is compact with a high density of fibers (e.g., 144F) while providing easy access for a technician to work on the system. In some implementations, the fiber distribution point system 10 is configured to be installed underground. In some implementations, the fiber distribution point system 10 provides splicing, patching, and splitting capabilities.

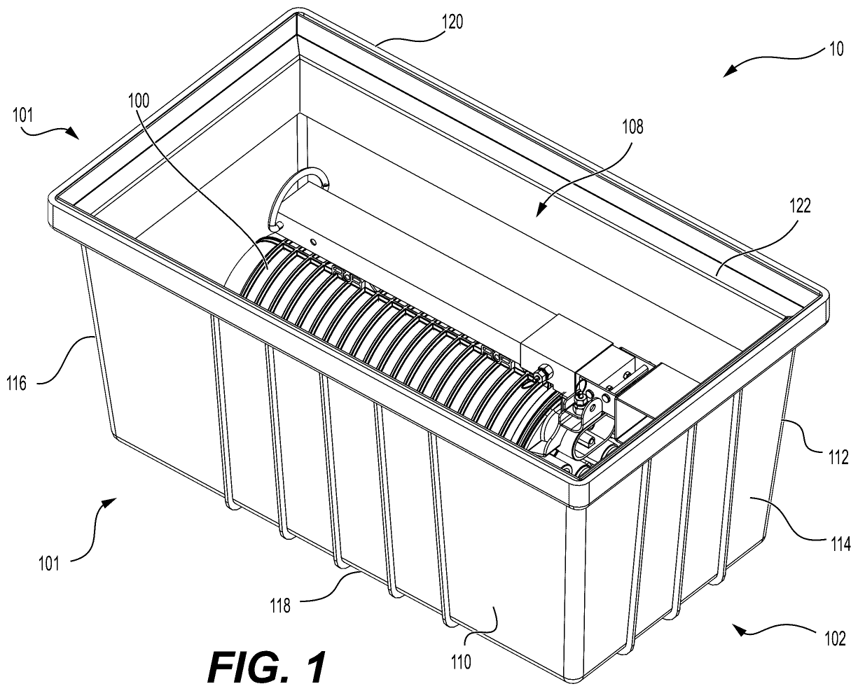

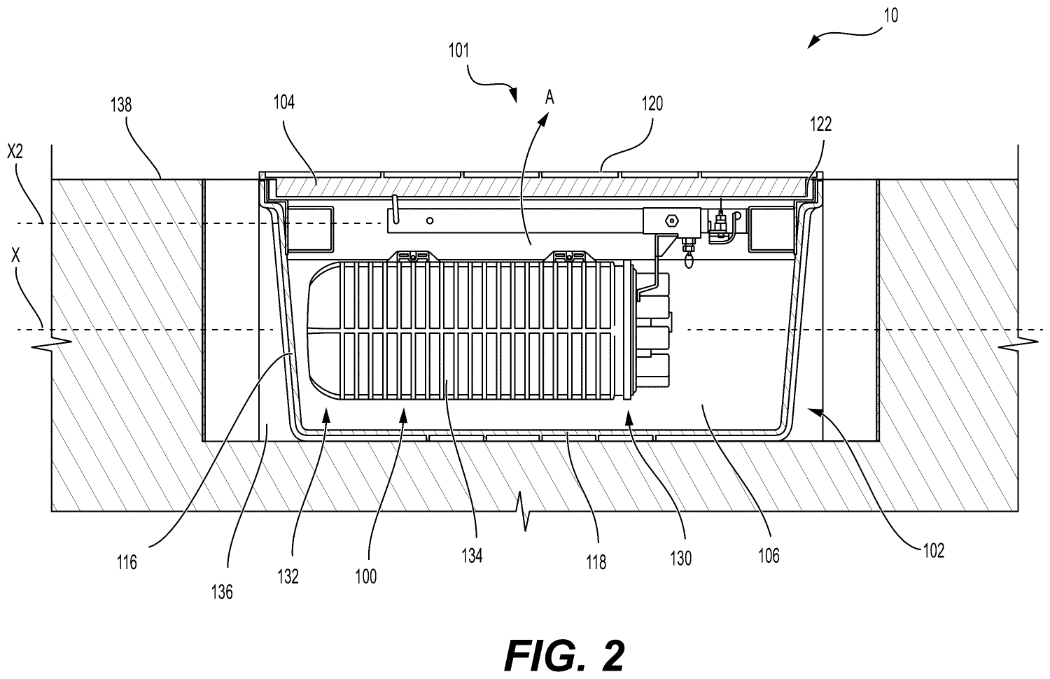

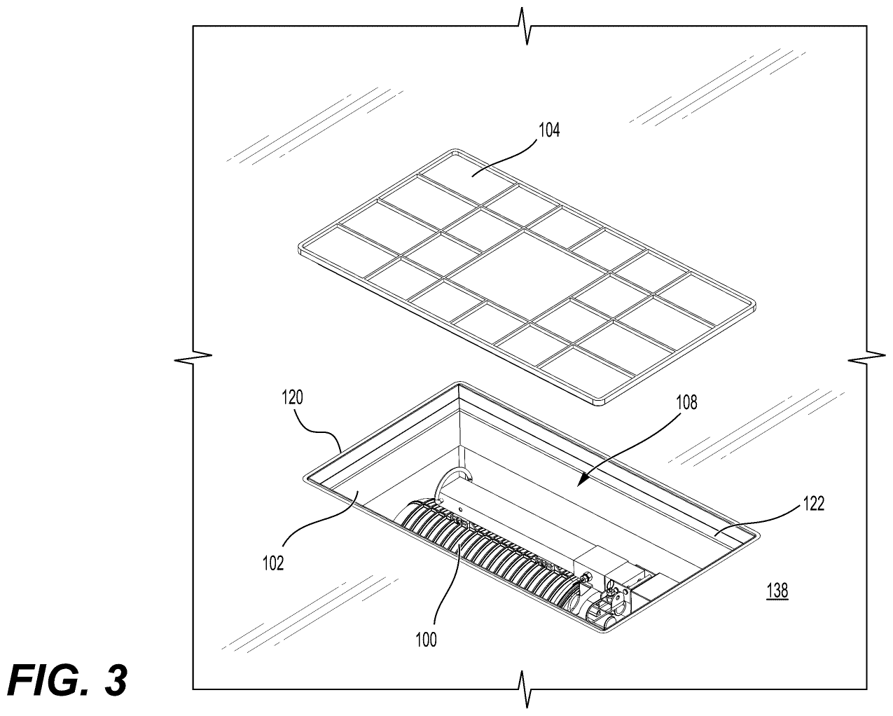

FIGS. 1-2 show an example fiber distribution point system 10, for example, a vault distribution point, in accordance with embodiments of the disclosure. The example fiber distribution point system 10 includes a fiber distribution point 100 (or fiber distribution portion) and an enclosure 101 configured to house the distribution point 100. The enclosure 101 has, in this example, a base or base portion 102 and a cover or cover portion 104. The base 102 defines an interior space 106 and an opening 108 to the interior space 106 and the cover 104 (see FIGS. 2-3) is configured to be received at the opening 108 to cover the interior space 106.

The base 102 can be configured in a variety of ways. In the illustrated implementation, the base 102 is a general cuboid-shaped. In other embodiments, however, the base 102 can be any suitable shape, such as, for example, cylindrical, trapezoidal prism, etc. The base 102 includes a first side wall 110, a second side wall 112 opposite the first side wall 110, a third side wall 114 extending between the first side wall 110 and the second side wall 112, and a fourth side wall 116 opposite the third side wall 114 and extending between the first side wall 110 and the second side wall 112. The base 102 includes a bottom wall 118 extending between the side walls 110, 112, 114, 116 which collectively define the interior space 106. The base 102 includes an upper lip or flange 120 defining the opening 108 to the interior space 106. In some implementations, the base 102 includes a recessed shoulder 122 configured to support the cover 104 when received at the opening 108 to the interior space 106.

The interior space 106 is configured to house the distribution point 100. As shown in FIG. 2, the interior space 106 is sized such that the distribution point 100 can be positioned entirely within the interior space 106. In various examples, the base 102 and the interior space 106 can be configured larger or smaller depending on the size of different configurations of the distribution point 100.

FIGS. 1-2 illustrate the distribution point 100 in a first position (i.e., a fully stored position in which the distribution point 100 is received within the interior space 106 of the base 102. In some implementations, the entire distribution point 100 is received within the interior space 106 in the first position.

The distribution point 100 can be configured in a variety of ways. In the illustrated implementation, the distribution point 100 has proximal end portion 130, and distal end portion 132 opposite the proximal end portion 130, and an external cover 134 that extends along a longitudinal axis X between the proximal end portion 130 and distal end portion 132. In some implementations, the external cover 134 has generally cylindrical dome-shape and has a hollow interior such that the operational components of the distribution point 100 can be housed inside. In some implementations, the external cover 134 has a length L in the range of 612 cm to 652 mm, or 622 mm to 642 mm, or approximately 632 mm, and an inner diameter D in the range of 220 mm to 260 mm, or 230 mm to 250 mm, or 240 mm. Thus, in some implementations, the external cover 134 can have an internal volume less than 32,000 cm³, or less than 30,000 cm³, or less than 29,000 cm³, or less than 28,600.0 cm³.

As shown in FIG. 2, in some implementations, when the distribution point 100 is in the first position, the longitudinal axis X of the distribution point 100 is generally horizontal (e.g., ±10 degrees) or generally parallel (e.g., ±10 degrees) to the bottom wall 118 of the base 102.

Referring to FIGS. 2-3, in some implementations, the base 102 is configured to be installed within cavity or recess 136 in a floor or a ground surface 138. For example, the base 102 can be received with the cavity or recess 136 such that the upper lip or flange 120 is flush or nearly flush with the floor or the ground surface 138. In some implementations, as shown in FIG. 2, the recessed shoulder 122 is configured to received and support the cover 104 such that the cover 104 is flush with or recessed relative to the upper lip or flange 120. Thus, in some implementations, the enclosure 101 provides a compact, covered, underground location to house the distribution point 100.

The enclosure 101 is configured to move the distribution point 100 between the first position (i.e., the stored position) to one or more other positions that provide better access for a technician to work on the distribution point 100. The enclosure 101 can be configured to move the distribution point 100 between the first position (i.e., the stored position) to one or more other positions in a variety of ways. For example, in some implementations the enclosure 101 can include a one or more mounting portions configured to move.

In the illustrated implementation, the enclosure 101 includes a first mounting portion 150, a second mounting portion 152, and a third mounting portion 154. The first mounting portion 150 is configured to move the fiber distribution point 100 between the first position where the distribution point 100 is received within the interior space 106 and a second position in which the distribution point 100 is exterior to the interior space 106. The first mounting portion 150 can be configured in a variety of ways.

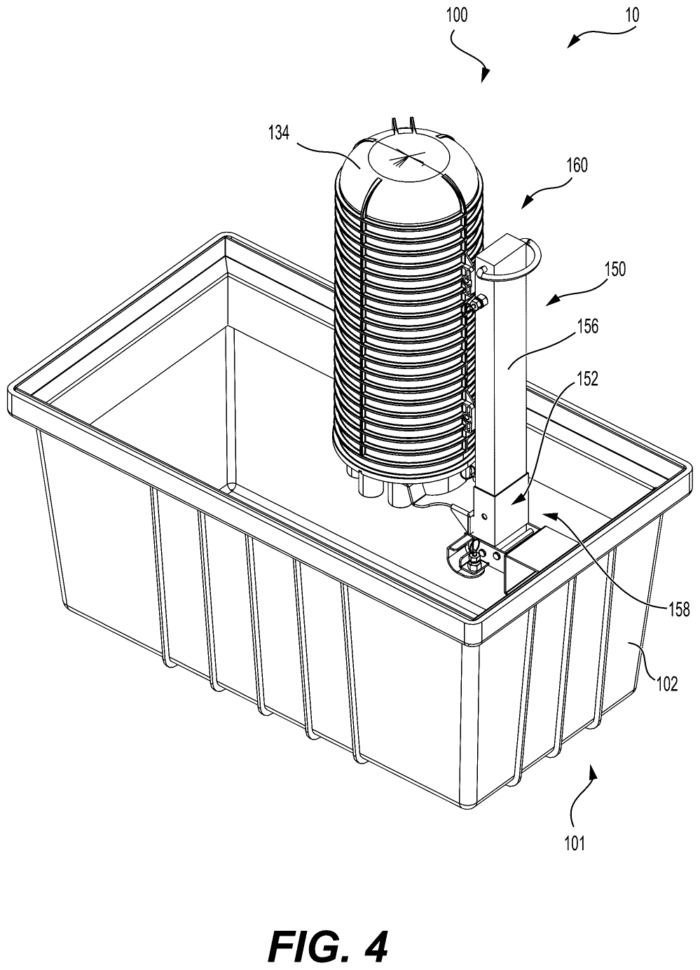

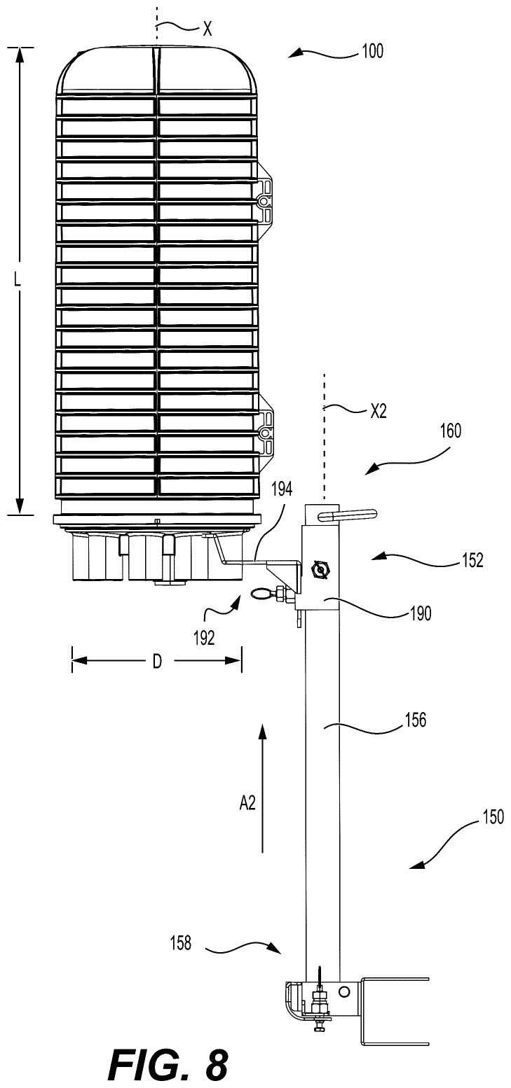

Referring to FIGS. 4 and 8, in the illustrated implementation, the first mounting portion 150 has a body portion 156, for example, an elongated body or elongated body portion (e.g., an arm, a shaft, a tube, a rod, a bar, etc.), extending along a longitudinal axis X2 (FIG. 8). The body 156 has a proximal end portion 158 connected to the base 102 and a distal end portion 160 opposite the proximal end portion 158. In the illustrated implementation, the elongated body 156 has a rectangular cross-sectional shape. In other implementations, however, the elongated body 156 can have a cross-sectional shape other than rectangular (e.g., round, oval, diamond, triangular, square, etc.).

In some implementations, the proximal end portion 158 is configured to connect to the base 102 via a connection configured to pivot the distribution point 100 from the first position as shown in FIGS. 1-2 to the second position, as shown in FIG. 4 and the arrow A in FIG. 2. In some implementations, when the distribution point 100 is in the first position, the elongated body 156 can be in a stored position, such as for example, generally horizontal (e.g., ±10 degrees) or generally parallel (e.g., ±10 degrees) to the bottom wall 118 of the base 102. Further, in some implementations, when the distribution point 100 is in the second position, the elongated body 156 can be an upright position, such as for example, generally vertical (e.g., ±10 degrees) or generally perpendicular (e.g., ±10 degrees) to the bottom wall 120 of the base 102.

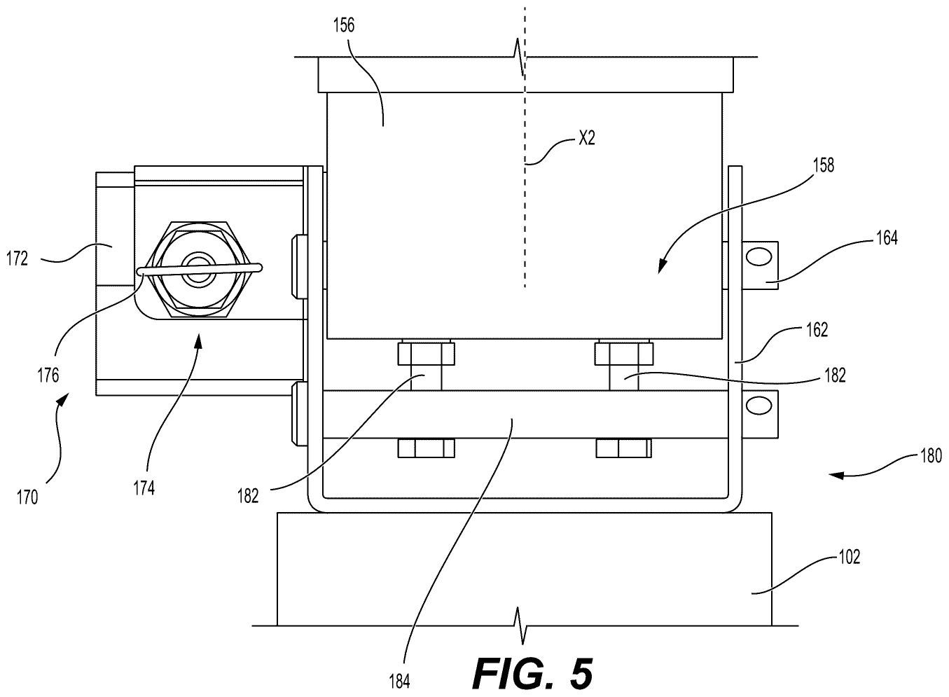

The proximal end portion 158 of the elongated body 156 can be connected to the base 102 in a variety of ways. Any suitable connection configured to pivot the elongated body 156 can be used. Referring to FIG. 5 in the illustrated implementation, the proximal end portion 158 of the elongated body 156 is connected to a bracket 162 by a pivot pin 164 about which the elongated body 156 pivots. The bracket 162 is fixed, directly or indirectly, to the base 102. In some implementations, the elongated body 156 is configured to pivot 90±15 degrees, or 90 degrees.

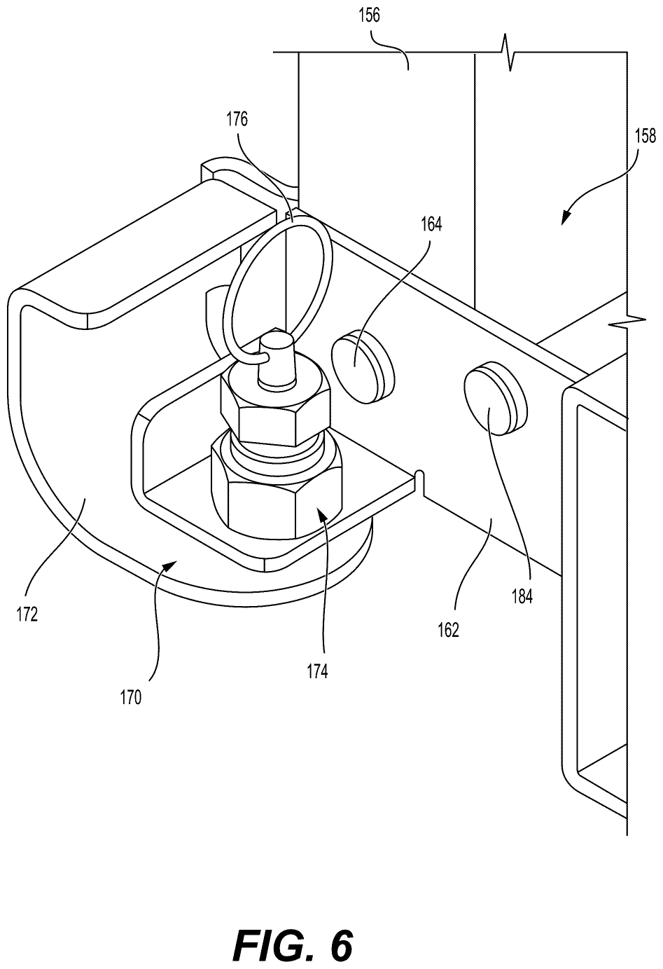

In some implementations, the first mounting portion 150 can be configured to lock in the upright position. The first mounting portion 150 can be configured to lock in the upright position in a variety of ways. In the illustrated implementation, the enclosure 101 includes a first locking portion or first locking mechanism 170 as shown in FIG. 6. The first locking mechanism 170 can be any suitable locking mechanism, such as a mechanical lock, for example. In some implementations, the first locking mechanism 170 includes a bracket 172 fixed to the proximal end portion 158 of the elongated body 156 for rotation therewith and a spring-loaded pin or plunger 174. The bracket 172 can include an aperture (not shown) that aligns with the pin 174 when the elongated body 156 is in the upright position such that the pin 174 is received within the aperture to lock the elongated body 156 in the upright position. The first locking mechanism 170 can include a pull ring 176 connected to the spring-loaded pin 174 to allow the first locking mechanism 170 to be manually released.

In some implementations, the first mounting portion 150 can include a stop portion 180 (FIG. 5) for positioning the elongated body 156 in the stored position. For example, the stop portion 180 can prevent the elongated body 156 from pivoting too far into the interior space 106 such that the distribution point 100 contacts the bottom wall 118. The stop portion 180 can be configured in a variety of ways. In the illustrated implementation, the stop portion 180 includes one or more projections 182 (e.g., bolts, pegs, rods, etc.) extending proximally from the proximal end portion 158 of the elongated body 156 and a cross member 184 (e.g., rod, pin, bolt, etc.) extending traverse to the longitudinal axis X2 of the elongated body 156. In the stored position, the projections 182 abut the cross member 184 to prevent the elongated body 156 from pivoting too far into the interior space 106.

In the second position, at least a portion of the distribution point 100 is exterior to the interior space 106, as shown in FIG. 4. In some implementations, the entire distribution point 100 is exterior to the interior space 106 in the second position.

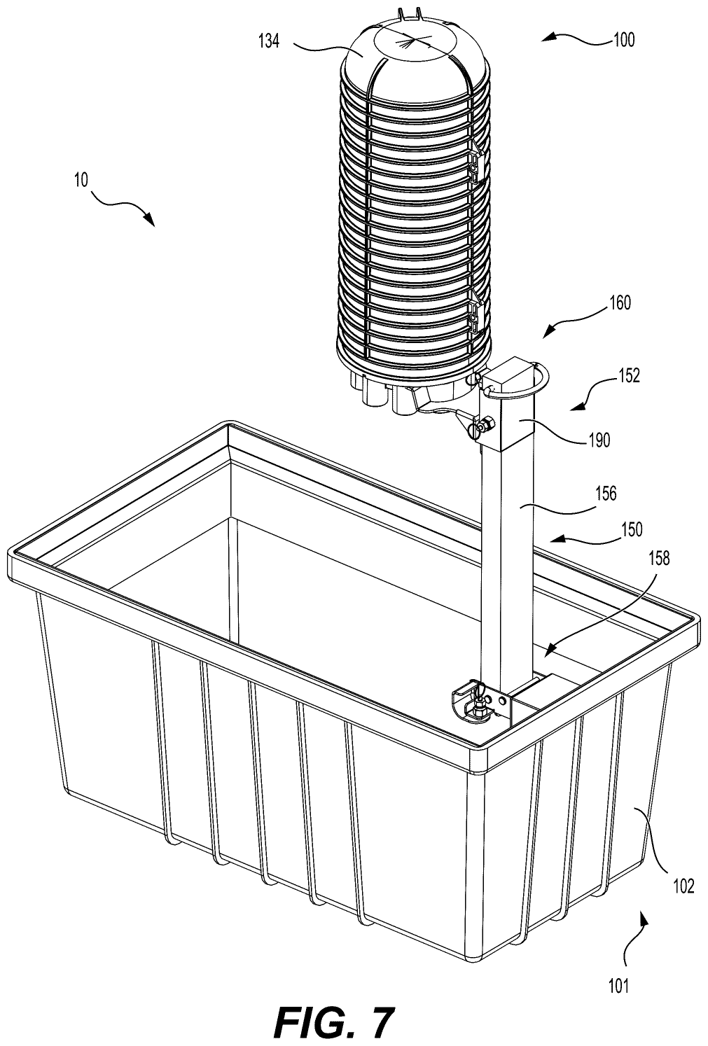

The second mounting portion 152 is configured to move the distribution point 100 between the second position, or unextended position, and a third position, or extended position, which is more distal to the base 102 than the second position. as shown in FIGS. 7-8, and by arrow A2 in FIG. 8. The second mounting portion 152 can be configured in a variety of ways. In the illustrated implementation, the second mounting portion 152 includes a translating portion or translating member 190 arranged on the elongated body 156 and an attachment portion or attachment member 192 associated with the distribution point 100 that is configured to be releasably attached to the translating member 190.

The translating member 190 is configured to move axially along the elongated body 156 between the proximal end portion 158 (e.g., the second position of the distribution point 100) and the distal end portion 160 (e.g., the third position of the distribution point 100). The translating member 190 can be configured in a variety of ways. In the illustrated implementation, the translating member 190 is configured as a sleeve that is configured to at least partially wraps around, and slide along, the elongated body 156. In some implementations, the translating member 190 can have a cross-sectional shape that is complementary to the cross-sectional shape of the shape elongated body 156 (e.g., rectangular).

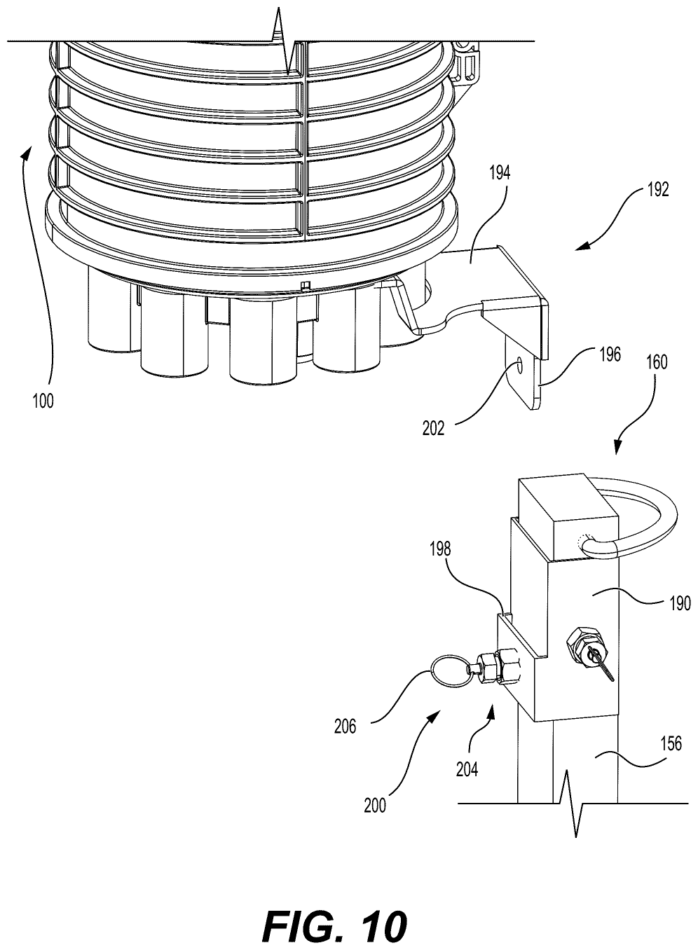

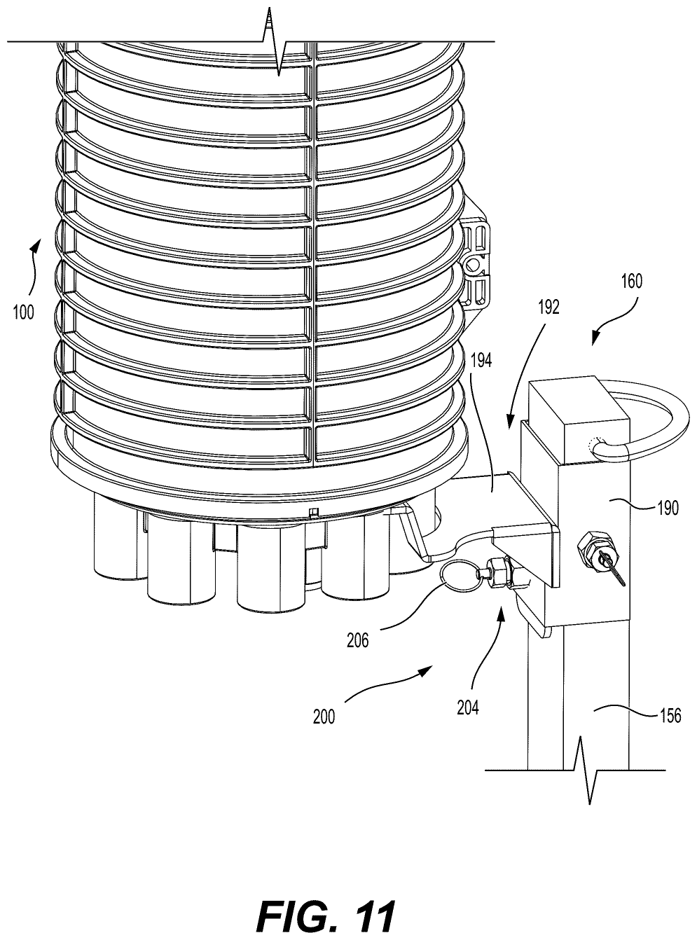

The attachment member 192 can be configured in a variety of ways, such as a bracket, link, connector, hook, or other suitable mechanical coupling. Referring to FIGS. 10-11, in the illustrated implementation, the attachment member 192 includes a bracket 194 and a projection 196 extending from the bracket 194. The projection 196 is configured to be received within a recess, gap, or slot 198 on the translating member 190 to attach the attachment member 192 to the translating member 190, as shown in FIG. 11.

In some implementations, the second mounting portion 152 can be configured to lock the attachment member 192 to the translating member 190, thereby locking the distribution point 100 to the enclosure 101. The attachment member 192 can lock to the translating member 190 in a variety of ways. In the illustrated implementation, the second mounting portion 152 includes a second locking portion or second locking mechanism 200 as shown in FIGS. 10-11. The second locking mechanism 200 can include an aperture 202 on the projection 196 and a spring-loaded pin or plunger 204. When the projection 196 is fully received in the recess, gap, or slot 198 on the translating member 190, the aperture 202 aligns with the pin 204 such that the pin 204 is received within the aperture 202 to lock the attachment member 192 to the translating member 190. The second locking mechanism 200 can include a pull ring 206 connected to the spring-loaded pin 204 to allow the second locking mechanism 200 to be manually released.

In some implementations, the second mounting portion 152 can be configured to lock the translating member 190 at various positions along the elongated body 156. Thus, the distribution point 100 can be locked at various positions along the elongated body 156, such as in second position, in the third position, and/or in one or more intermediate positions between the second position and the third position. The second mounting portion 152 can be configured to lock the translating member 190 at various positions along the elongated body 156 in a variety of ways.

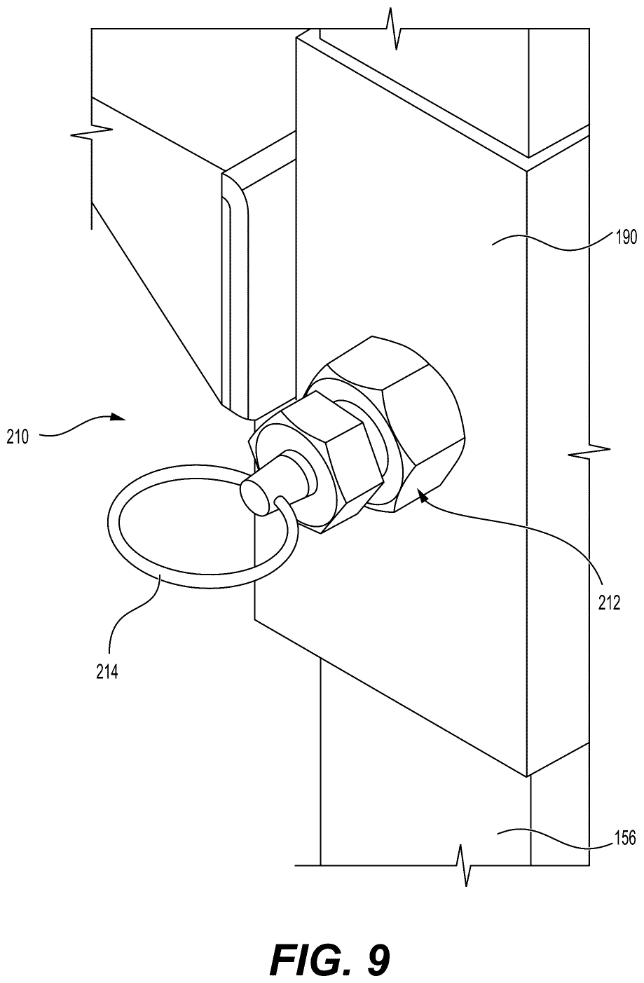

Referring to FIG. 9, in some implementations, the second mounting portion 152 includes a third locking portion or third locking mechanism 210 as shown in FIG. 9. For example, the elongated body 156 can include a plurality of apertures (not shown) spaced apart along a length of the elongated body 156 and the translating member 190 can include a spring-loaded pin or plunger 212. When the translating member 190 is positioned such that the pin 204 aligns with one of the plurality of apertures, the pin 204 is received within the aperture to lock the translating member 190 relative to the elongated body 156, thus locking the position of the distribution point 100 relative to the elongated body 156. The third locking mechanism 210 can include a pull ring 214 connected to the spring-loaded pin 212 to allow the third locking mechanism 210 to be manually released.

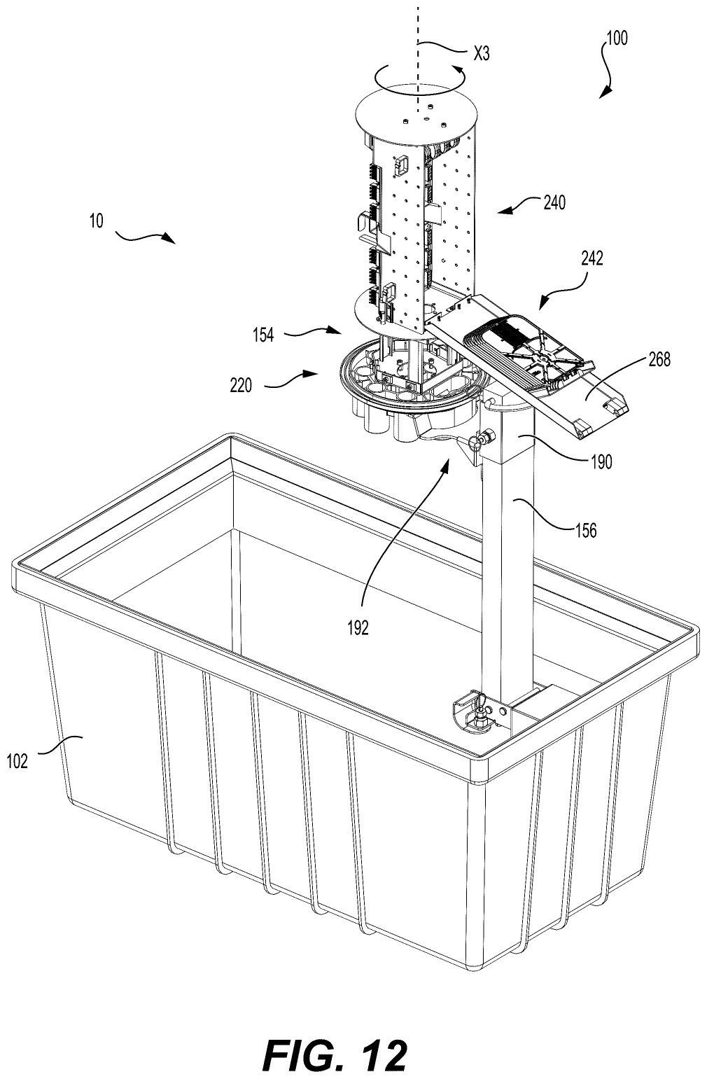

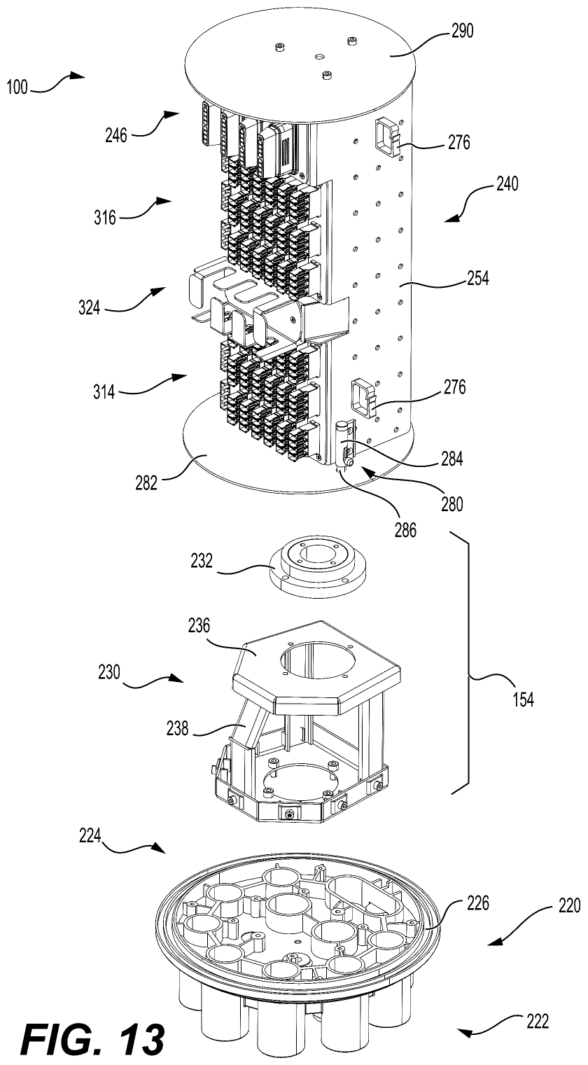

Referring to FIGS. 12-13, the distribution point 100 is illustrated with the external cover 134 removed. In some implementations, the fiber distribution point system 10 includes an end cap 220. The end cap 220 can, in some implementations, be configured to attach to the attachment member 192 to attach the distribution point 100 to the enclosure 101. The end cap 220 can be configured in a variety of ways. In the illustrated implementation, the end cap 220 generally disc-shaped having a proximal end 222 and a distal end 224 opposite the proximal end 222. The end cap 220 can include one or more passages that extend through the end cap 220 from the proximal end 222 to the distal end 224 for routing cable.

In some implementations, the end cap 220 can be configured to include a cover mounting portion 226 (e.g., an annular groove on the distal end 224) for attaching to and supporting the external cover 134 over the distribution point 100. In addition, in some implementations, the end cap 220 can be configured to support the distribution point 100. In the illustrated implementation, the distribution point 100 is mounted to the end cap 220 by the third mounting portion 154.

The third mounting portion 154 is configured to allow rotation of the distribution point 100 about an axis of rotation X3 relative to the enclosure 101, as shown by arrow A3 in FIG. 12. The third mounting portion 154 can be configured in a variety of ways. In the illustrated implementation, the third mounting portion 154 includes a base or base portion 230 and a rotational portion or rotational element 232. The base 230, in the illustrated implementation, attaches to the distal end 224 of the end cap 220 and is configured to mount the rotational element 232. In some implementations, the base 230 includes a platform 236 spaced apart from the distal end 224 of the end cap 220 and supported by a plurality of legs 238.

The rotational element 232 is configured to engage the distribution point 100 to allow rotation of the distribution point 100 relative to the base 230. The rotational element 232 can be configured in a variety of ways, such as for example, any suitable bearing. In some implementations, the rotational element 232 can mount onto the platform 236 between the platform 236 and the distribution point 100.

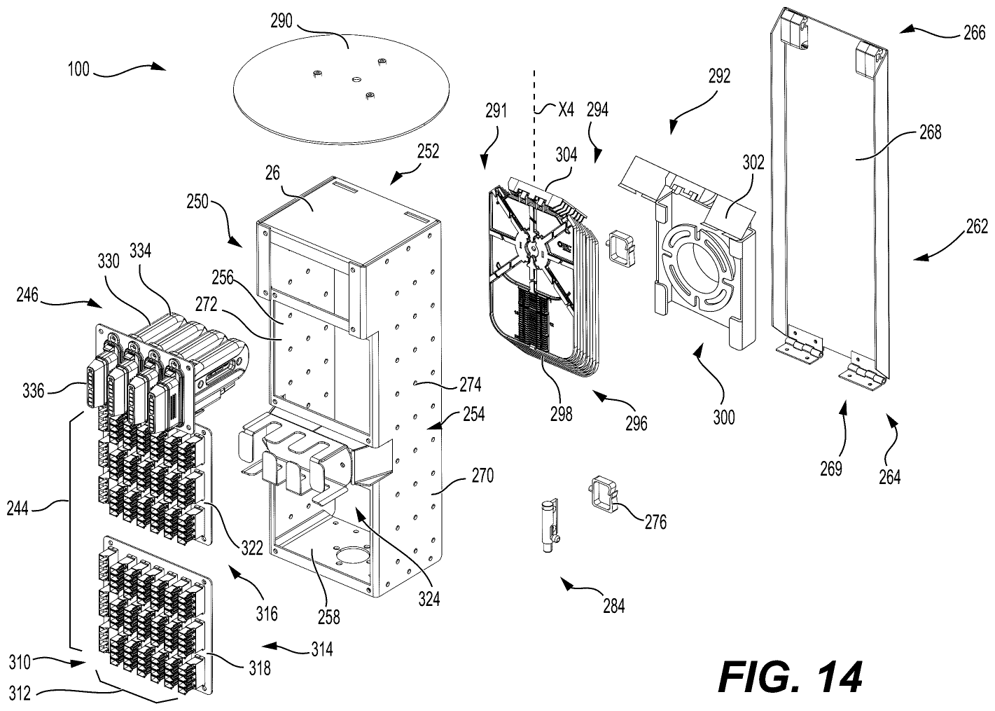

Referring to FIG. 14, the distribution point 100 is configured to provide a high-density assembly (i.e., high number of fibers, such as 144F or more) in a compact space (e.g., the internal volume of the external cover 134) while providing splicing, splitting, and patching capabilities. The distribution point 100 can be configured in a variety of ways. In the illustrated implementation, the distribution point 100 includes a frame portion 240, a splicing portion 242, a patching portion 244, and a splitting portion 246.

The frame portion 240 is configured to support the splicing portion 242, the patching portion 244, and the splitting portion 246. The frame portion 240 can be configured in a variety of ways. In the illustrated implementation, the frame portion 240 is generally cuboid-shaped having a front side 250, a back side 252 opposite the front side 250, a first lateral side 254 extending between the front side 250 and the back side 252, a second lateral side 256 opposite the first lateral side 254 and extending between the front side 250 and the back side 252, a bottom side 258 extending between the front side 250 and the back side 252, and a top side 260 opposite the bottom side 258 and extending between the front side 250 and the back side 252.

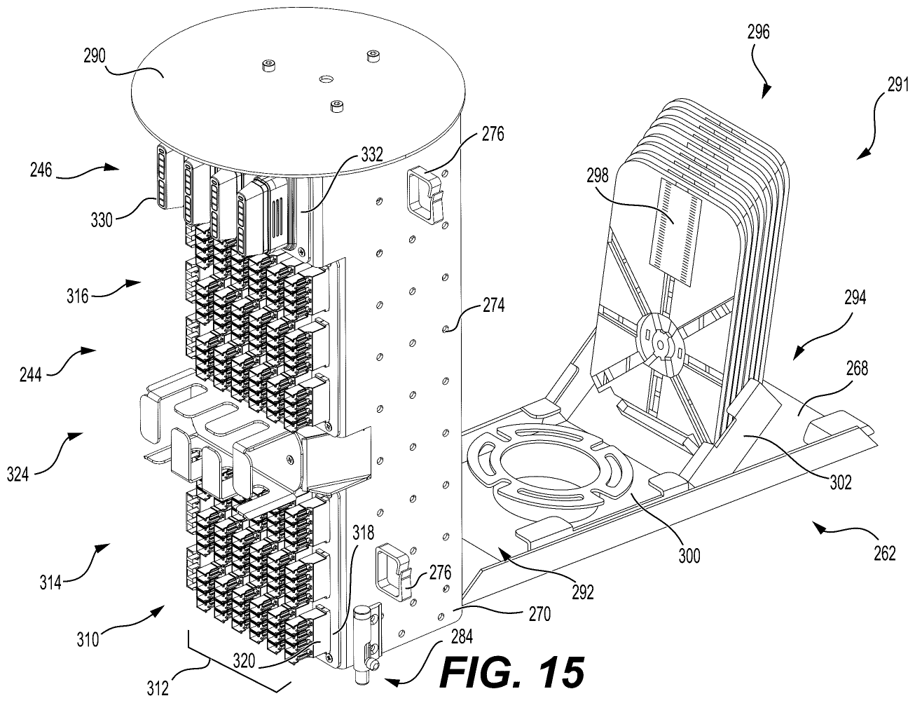

In some implementations, the back side 252 includes a panel 262. The panel 262 can include a bottom portion 264, a top portion 266 and an inner face 268 extending between the bottom portion 264 and the top portion 266. In some implementations, the panel 262 is configured to pivot away relative to the bottom portion 264. For example, in the illustrated implementation, the bottom portion 264 of the panel 262 is connected to the frame portion 240 at or near the bottom side 258 by a pivot connection 269 (e.g., one or more hinges) such that the top portion 266 of the panel 262 can pivot outward, as shown in FIGS. 12 and 15.

In some implementations, the first lateral side 254 and the second lateral side 256 define a first lateral side wall 270 and second lateral side wall 272, respectively. In some implementations, the first lateral side wall 270 and/or the second lateral side wall 272 includes one or more apertures 274 configured to route cable therethrough. In some implementations, as shown in FIG. 14, the first lateral side wall 270 and/or the second lateral side wall 272 each include a plurality of spaced-apart apertures 274. In some implementations, the plurality of spaced-apart apertures 274 can be arranged in rows extending along the side walls 270, 272. In some implementations, one or more cable management device 276, such as a cable management clip, can be attached to the one or both side walls 270, 272 to manage any cables extending through the one or more apertures 274.

In some implementations, the fiber distribution point system 10 can include a fourth locking portion or fourth locking mechanism 280 (FIG. 13) configured to lock the distribution point 100 at various degrees of rotation about the axis of rotation X3. The fourth locking mechanism 280 can be any suitable locking mechanism, such as a mechanical lock, for example. In some implementations, the fourth locking mechanism 280 includes a base 282 and a spring lock 284 (e.g., spring loaded pin, latch, etc.). The base 282 can be fixed to the base 230 of the third mounting portion 154 and thus stationary relative to rotation of the distribution point 100. In the illustrated implementation, the base 282 is disc-shaped and includes one or more apertures 286.

The spring lock 284 may be attached to the distribution point 100 for rotation therewith. In the illustrated implementation, the spring lock 284 may be mounted onto the first lateral side wall 270 adjacent the bottom side 258 of the frame portion 240. The distribution point 100 can be locked in place rotationally at various degrees of rotation about the axis X3 where one or more apertures 286 aligns with the spring lock 284 such that the spring lock 284 can be received in one of the apertures 286.

In some implementations, the distribution point 100 may include a guide portion 290 configured to guide the external cover 134 onto and off of the distribution point 100. The guide portion 290 can be configured in a variety of ways. In some implementations, the guide portion 290 may be structurally configured to mount onto the top side 260 of the frame portion 240. In some implementations, the guide portion 290 can have shape that is complementary to a shape of the hollow interior of the external cover 134. For example, in some implementations, the guide portion 290 is disc-shaped where the external cover has a circular cross-section shaped hollow interior.

Referring to FIGS. 14-15, the splicing portion 242 is configured to mount a plurality of spliced together fiber cables. The splicing portion 242 can be configured in a variety of ways. In the illustrated implementation, the splicing portion 242 includes a plurality of splice holders 291 and a splice holder base 292. The splice holders 291 can be configured in a variety of ways. In the illustrated implementation, each splice holder 291 is configured as a tray or card having a proximal end 294, a distal end 296, a longitudinal axis X4, and a fiber retaining portion 298. The fiber retaining portion 298 is configured to hold a plurality of pairs of spliced together fibers in a parallel, spaced-apart orientation. The number of pairs of spliced together fibers each splice holder 291 can hold can vary in different implementations. In some implementations, each splice holder 291 can hold 18-30 pairs of spliced together fibers, or 20-28 spliced together fibers, or 24 spliced together fibers.

The splice holder base 292 is configured to support the plurality of splice holders 291. The splice holder base 292 can be configured in a variety of ways. In the illustrated implementation, the splice holder base 292 includes a first portion 300 configured to attach to the inner face 268 of the panel 262 and a second portion 302 configured to mount the splice holders 291. The number of splice holders 291 that the splice holder base 292 can support can vary in different implementations. In some implementations, the splice holder base 292 is configured to support 6-10 splice holders 291, or 8 slice holders.

In some implementations, the splice holders 291 are configured to pivot relative to the splice holder base 292. For example, each splice holder 291 can be connected to the splice holder base 292 by a pivot connection 304. In the illustrated implementation, the proximal end 294 of each splice holder 291 is connected to the splice holder base 292 via the pivot connection 304 located on the second portion 302 of the splice holder 291. In the illustrated implementation, the second portion 302 extends outward from the first portion 300 at an angle (e.g., 15-45 degrees). In some embodiments, the splice holder base 292 is configured to mount the splice holders 291 in a stacked arrangement.

In some implementations, the splice holders 291 are configured to pivot from a first position (e.g., a stored or closed position) as shown in FIG. 12 to a second position (e.g., an open position where the splice holders are more accessible for a technician to work on) as shown in FIG. 15. In some implementations, in the first position, the longitudinal axis X4 of each of the splice holders 291 is oriented generally parallel (e.g., ±10 degrees) to the first portion 300 of the splice holder base 292 and/or generally parallel (e.g., ±10 degrees) to the inner face 268 of the panel 262. In some implementations, in the second position, the longitudinal axis X4 of each of the splice holders 291 is oriented generally perpendicular (e.g., 80-100 degrees) to the first portion 300 of the splice holder base 292 and/or generally perpendicular (e.g., 80-100 degrees) to the inner face 268 of the panel 262.

The patching portion 244 is configured as the fiber input and fiber output portion of the distribution point 100. For example, in some implementations, the patching portion 244 includes a plurality of input ports 310 configured to receive and arrange fibers coming into the distribution point 100 and a plurality of output ports 312 configured to receive and arrange fibers outgoing from the distribution point 100. The patching portion 244 can be configured in a variety of ways.

In the illustrated implementations, the patching portion 244 includes a first patching arrangement 314 and a second patching arrangement 316. Each of the first patching arrangement 314 and the second patching arrangement 316 includes a plurality of input ports 310 and a plurality of output ports 312. In some implementations, the first patching arrangement 314 and a second patching arrangement 316 are configured the same (e.g., the same number of input and output ports, the same arrangement and orientations of the ports, etc.). In other implementations, however, the first patching arrangement 314 and the second patching arrangement 316 can differ.

In the illustrated implementation, the first patching arrangement 314 includes a plurality of input ports 310 and a plurality of output ports 312 arranged on a base 318 (e.g., substrate, panel, board, etc.). In some implementations, the plurality of input ports 310 are arrange in one or more columns and the plurality of output ports 312 are arranged in one or more separate columns. In some implementations, a plurality of the output ports 312 can be arranged on an adapter or module 320 and multiple adapters or modules can be utilized in the patching portion 244.

For example, in the illustrated implementation, the first patching arrangement 314 includes three adapters or modules 320, each having four input ports 310, arranged in a column on the base 318. Thus, in some implementations, the first patching arrangement 314 includes twelve input ports 310. In some implementations, the first patching arrangement 314 includes eighteen adapters or modules 320, each having four output ports 312. The eighteen adapters or modules 320 are arranged in six columns of three adapters or modules each. Thus, in some implementations, the first patching arrangement 314 includes seventy-two (72) input ports 310. Each of the input ports 310 and the output ports 312 can be any suitable configuration. For example, in some implementations, the input ports 310 and the output ports 312 are configured as LC connectors.

In the illustrated implementation, the second patching arrangement 316 is configured the same as the first patching arrangement 314 and, thus, includes three input adapters or modules 320, each having four input ports 310, arranged in a column on a second base 322 for a total of twelve input ports 310. Further, the second patching arrangement 316 includes eighteen output adapters or modules 320, each having four output ports 312, arranged in six columns of three adapters or modules each for a total of seventy-two (72) output ports 312. Thus, in some implementations, the distribution point 100 has a total of one hundred forty-four (144) output ports.

In some implementations, both the first patching arrangement 314 and the second patching arrangement 316 can be attached to the front side of the frame portion 240. In some implementations, the first patching arrangement 314 is attached to the front side of the frame portion 240 and spaced apart from the second patching arrangement 316 by a cable management portion 324 configured to hold a plurality of cables to prevent the cables from entangling and to manage the routing of the cables relative to the distribution point 100.

The splitting portion 246 is configured to receive a fiber cable or fibers as input and split the fiber cable or fibers into multiple outputs. The splitting portion 246 can be configured in a variety of ways. In some implementations, the splitting portion 246 include a plurality of fiber splitters 330. The number and arrangement of fiber splitters 330 can vary in different implementations. In some implementations, the splitting portion 246 includes a plurality of fiber splitters 330 arranged side-by-side in a row on a base 332 (e.g., substrate, panel, board, etc.). In some implementations, the splitting portion 246 includes four fiber splitters 330 arranged side-by-side.

Each fiber splitter 330 can be configured in a variety of ways, including the number of input ports and the number of output ports per fiber splitter. In some implementations, each fiber splitter 330 includes one or more splitter input ports 334 and a plurality of splitter output ports 336. In some implementations, each fiber splitter 330 include a single splitter input port 334 and thirty-two splitter output ports 336. Thus, in some implementations, the splitting portion 246 includes four splitter input ports 334 and one hundred twenty-eight (128) splitter output ports 336.

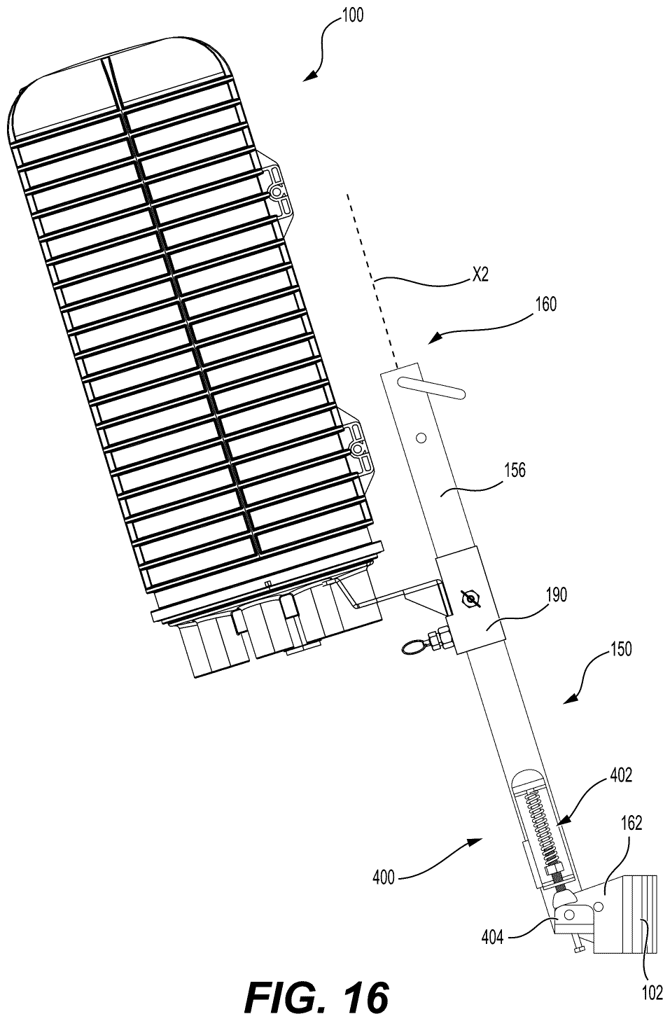

Referring to FIGS. 16-18, an example implementation of a retaining or locking mechanism 400 configured to hold the first mounting portion 150 in position, along the pivotal range of the first mounting portion 150. The retaining or locking mechanism 400 can be configured in a variety of ways. In some implementations, the retaining or locking mechanism 400 can hold or lock the first mounting portion 150 in any position within the pivotal range of the first mounting portion 150 (e.g., from the first position to the second position of the distribution point 100). In some implementations, the retaining or locking mechanism 400 can be used in conjunction with the first locking mechanism 170. In other implementations, the retaining or locking mechanism 400 can be used as an alternative to the first locking mechanism 170.

In the illustrated implementation, the retaining or locking mechanism 400 includes a biased stop 402 and a cam portion 404. The cam portion 404 can be configured in a variety of ways. In some implementations, the cam portion 404 is fixed relative to the base 102 (e.g., on the bracket 162). In some implementations, the cam portion 404 is coaxially arranged with the pivot pin 164. In the illustrated implementation, the cam portion 404 includes an exterior surface 406 having an oval-shaped profile. In other embodiments, however, the exterior surface 406 can have any suitably shaped profile.

The exterior surface 406 of the cam portion 404 is configured to contact the biased stop 402. The biased stop 402 can be configured in a variety of ways. In the illustrated implementation, the biased stop 402 includes a plunger or pin 410, a biasing element 412 (e.g., spring), and a bracket 414. The plunger or pin 410 can include a head portion 416 and a shaft portion 418. The bracket 414 can be configured to support the plunger or pin 410 for movement in the direction of the longitudinal axis X2 of the elongated body 156. In some embodiments, the bracket 414 is fixed to the elongated body 156 and the shaft portion 418 of the plunger or pin 410 extends through the bracket 414.

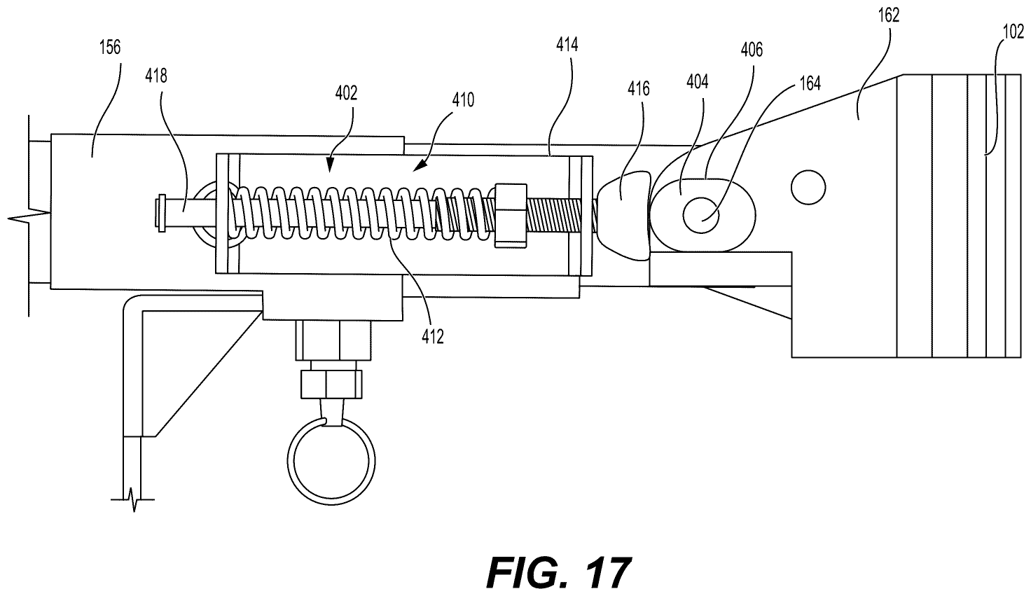

The biasing element 412 can be arranged to bias the plunger or pin 410 toward the cam portion 404, and thus the head portion 416 against the exterior surface 406. As a result, in some implementations, the frictional forces created between the head portion 416 and exterior surface 406 are sufficient to hold the elongated body 156 in any angular position within the pivotal range of the elongated body 156. For example, FIG. 16 illustrates the elongated body 156 at approximately 70 degrees rotation from the stored position as shown in FIG. 17.

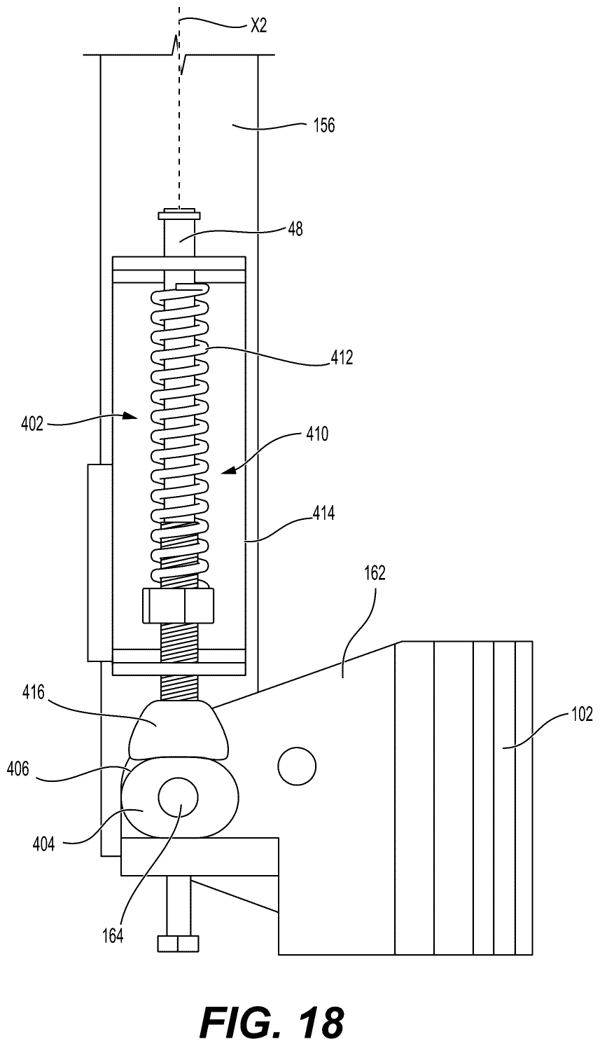

In some implementations, the profile of the exterior surface 406 of the cam portion 404 can be configured to change the frictional forces between the head portion 416 and exterior surface 406 at different angular positions of the elongated body 156. For example, the oval-shaped profile of the example cam portion 404 of FIGS. 17-18 results in greater forces between the head portion 416 and exterior surface 406 in the first position (FIG. 17) than in the second position (FIG. 18) due to greater compression of the biasing element 412 in the first position.

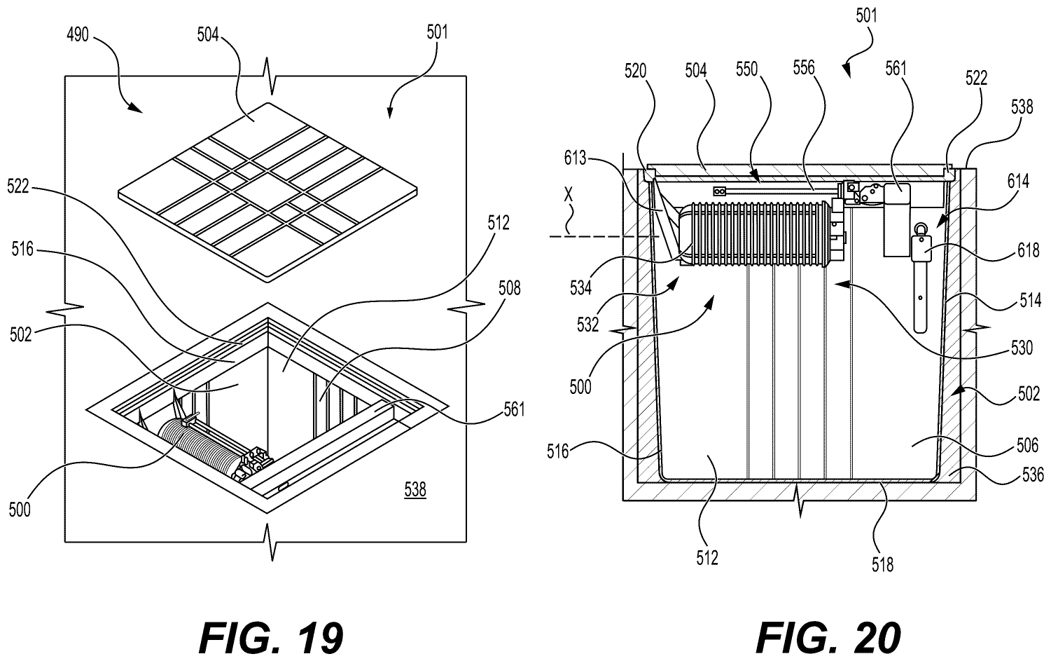

FIGS. 19-20 show an example fiber distribution point system 490, for example, a vault distribution point, in accordance with embodiments of the disclosure. The example fiber distribution point system 490 includes a fiber distribution point 500 (or fiber distribution portion) and an enclosure 501 configured to house the distribution point 500. The enclosure 501 has, in this example, a base or base portion 502 and a cover or cover portion 504. The base portion 502 defines an interior space 506 and an opening 508 to the interior space 506 and the cover portion 504 is configured to be received at the opening 508 to cover the interior space 506.

The base portion 502 can be configured in a variety of ways. In the illustrated implementation, the base portion 502 is a general cuboid-shaped. In other embodiments, however, the base portion 502 can be any suitable shape, such as, for example, cylindrical, trapezoidal prism, etc. In some embodiments, the base portion 502 may have a generally square cross-sectional profile and opening 508.

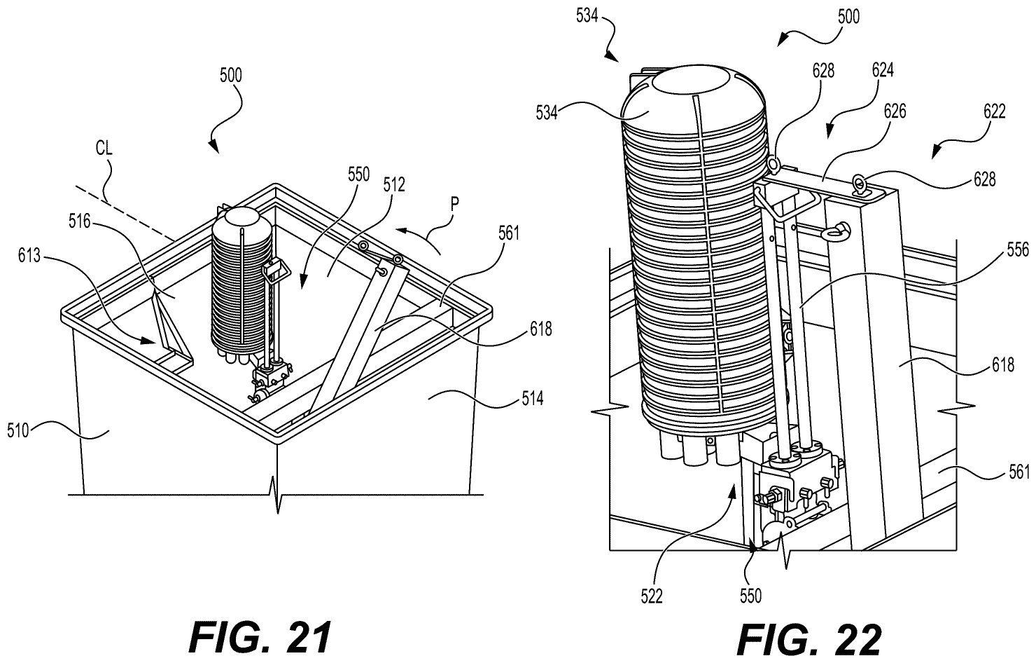

The base portion 502 may include a first side wall 510 (FIG. 21), a second side wall 512 opposite the first side wall 510, a third side wall 514 extending between the first side wall 510 and the second side wall 512, and a fourth side wall 516 opposite the third side wall 514 and extending between the first side wall 510 and the second side wall 512. The base portion 502 may include a bottom wall 518 extending between the side walls 510, 512, 514, 516 which may collectively define the interior space 506. The base portion 502 may include an upper lip or flange 520 defining the opening 508 to the interior space 506. In some implementations, the base portion 502 may include a recessed shoulder 522 configured to support the cover portion 504 when received at the opening 508 to the interior space 506.

The interior space 506 may be configured to house the distribution point 500. As shown in FIG. 20, the interior space 506 is sized such that the distribution point 500 can be positioned entirely within the interior space 506. In various examples, the base portion 502 and the interior space 506 can be configured larger or smaller depending on the size of different configurations of the distribution point 500 or need for space (e.g., to store slack cable).

FIGS. 19-20 illustrate the distribution point 500 in a first position (i.e., a fully stored position in which the distribution point 500 may be received within the interior space 506 of the base portion 502. In some implementations, the entire distribution point 500 may be received within the interior space 506 in the first position.

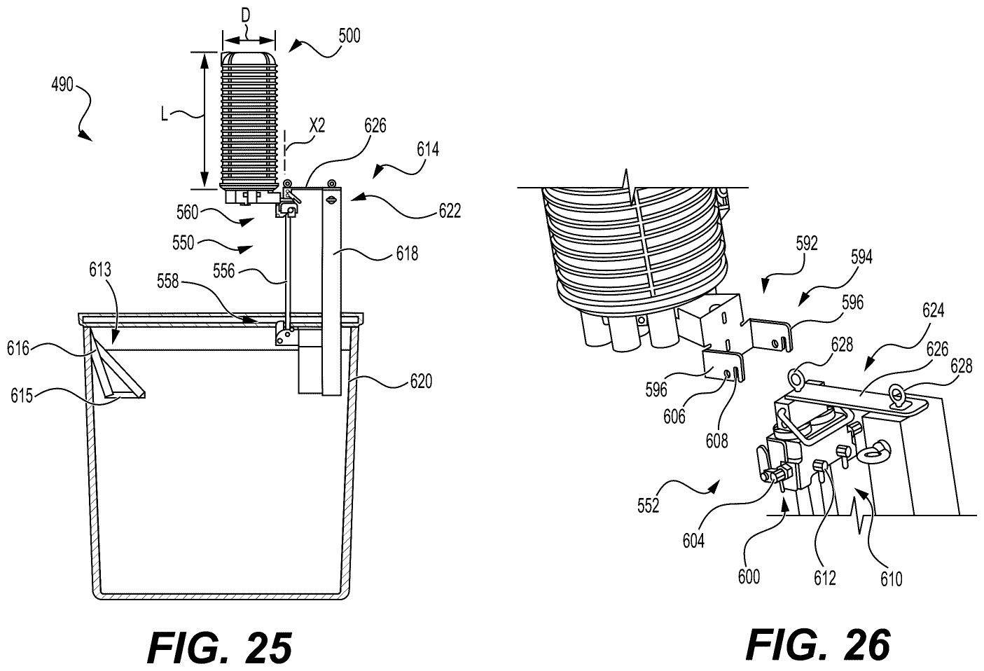

The distribution point 500 can be configured in a variety of ways. In the illustrated implementation, the distribution point 500 may have a proximal end portion 530, and distal end portion 532 opposite the proximal end portion 530, and an external cover 534 that extends along a longitudinal axis X between the proximal end portion 530 and distal end portion 532 (FIG. 2). In some implementations, the external cover 534 may have a generally cylindrical dome-shape and a hollow interior such that the operational components of the distribution point 500 may be housed inside. In some implementations, the external cover 534 may have a length L (FIG. 25) in the range of 612 cm to 652 mm, or 622 mm to 642 mm, or approximately 632 mm, and an inner diameter D (FIG. 25) in the range of 220 mm to 260 mm, or 230 mm to 250 mm, or 240 mm. Thus, in some implementations, the external cover 134 may have an internal volume less than 32,000 cm³, or less than 30,000 cm³, or less than 29,000 cm³, or less than 28,600.0 cm³.

As shown in FIG. 20, in some implementations, when the distribution point 500 is in the first position, the longitudinal axis X of the distribution point 500 may be generally horizontal (e.g., ±10 degrees) or generally parallel (e.g., ±10 degrees) to the bottom wall 518 of the base portion 502.

Referring to FIG. 20, in some implementations, the base portion 502 may be configured to be installed within a cavity or recess 536 in a floor or a ground surface 538. For example, the base portion 502 can be received with the cavity or recess 536 (such that the upper lip or flange 520 is flush or nearly flush with the floor or the ground surface 538. In some implementations, as shown in FIG. 20, the recessed shoulder 522 is configured to received and support the cover portion 504 such that the cover portion 504 is flush with or recessed relative to the upper lip or flange 520. Thus, in some implementations, the enclosure 501 provides a compact, covered, underground location to house the distribution point 500.

The enclosure 501 may be configured to move the distribution point 500 between the first position (i.e., the stored position) to one or more other positions that provide better access for a technician to work on the distribution point 500. The fiber distribution point system 490 may be configured to move the distribution point 500 between the first position (i.e., the stored position) to one or more other positions in a variety of ways. For example, in some implementations the enclosure 501 may include one or more mounting portions structurally configured to move.

In some implementation, the enclosure 501 may include a first mounting portion 550, a second mounting portion 552, and a third mounting portion 554. The first mounting portion 550 may be structurally configured to move the fiber distribution point 500 between the first position where the distribution point 500 is received within the interior space 506 and a second position in which the distribution point 500 is exterior or at least partially exterior, to the interior space 506. The first mounting portion 550 can be configured in a variety of ways.

Referring to FIG. 21-25, in the illustrated implementation, the first mounting portion 550 may have an elongated body portion 556 (e.g., an arm, a shaft, a tube, a rod, a bar, etc.) extending along a longitudinal axis X2 (FIG. 25). The elongated body portion 556 may have a proximal end portion 558 connected to the base portion 502 and a distal end portion 560 opposite the proximal end portion 558. In the illustrated implementation, the elongated body portion 556 may include a pair of parallel-extending cylindrical rods. In other implementations, however, the elongated body portion 556 may have a cross-sectional shape other than cylindrical (e.g., rectangular, oval, diamond, triangular, square, etc.).

In some implementations, the proximal end portion 558 may be structurally configured to connect to the base portion 502 via a connection structurally configured to pivot the distribution point 500 from the first position, as shown in FIGS. 19-20, to the second position, as shown in FIGS. 21-22. In some implementations, when the distribution point 500 is in the first position, the body portion 556 may be in a stored position, such as for example, generally horizontal (e.g., ±10 degrees) or generally parallel (e.g., ±10 degrees) to the bottom wall 518 of the base portion 502. Further, in some implementations, when the distribution point 500 is in the second position, the elongated body portion 556 may be an upright position, such as for example, generally vertical (e.g., ±10 degrees) or generally perpendicular (e.g., ±10 degrees) to the bottom wall 518 of the base portion 502.

The proximal end portion 558 of the elongated body portion 556 may be connected to the base portion 502 in a variety of ways. Any suitable connection configured to pivot the elongated body portion 556 may be used. In some implementations, the base portion 502 may include a cross-support portion 561 extending between the first side wall portion 510 to the second side wall portion 512.

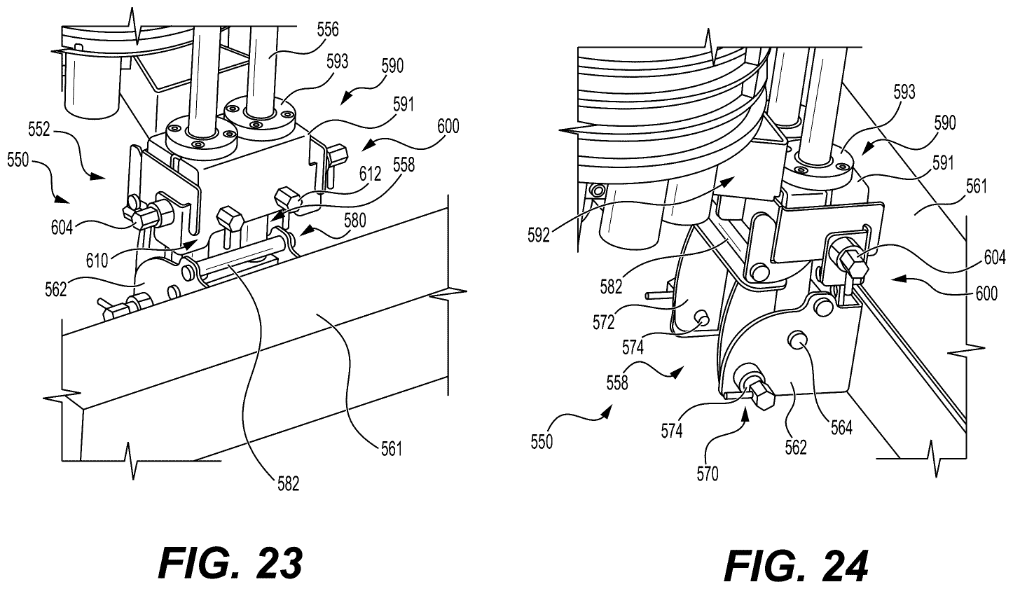

Referring to FIGS. 23-24, in the illustrated implementation, the proximal end portion 558 of the elongated body portion 556 may be connected to a bracket portion 562 by a pivot pin 564 about which the elongated body portion 556 may pivot. The bracket portion 562 may be fixed, directly or indirectly, to the base portion 502 (e.g., via the cross support portion 561). In some implementations, the elongated body portion 556 may be configured to pivot 90±15 degrees, or 90 degrees.

In some implementations, the first mounting portion 550 may be configured to lock in the upright position. The first mounting portion 550 can be configured to lock in the upright position in a variety of ways. In the illustrated implementation, the enclosure 501 may include a first locking portion or first locking mechanism 570 as shown in FIG. 24. The first locking mechanism 570 can be any suitable locking mechanism, such as a mechanical lock, for example. In some implementations, the first locking mechanism 570 may include bracket portion 572 fixed to the proximal end portion 558 of the elongated body portion 556 for rotation therewith and one or more spring-loaded pins or plungers 574. The bracket portion 572 may include one or more apertures (not shown) that align with a corresponding spring-loaded pins or plungers 574 when the elongated body portion 556 is in the upright position such that each of the one or more spring-loaded pins or plungers 574 may be received within a corresponding one of the apertures to lock the elongated body portion 556 in the upright position.

In some implementations, the first mounting portion 550 may include a stop portion 580 (FIG. 23) for positioning the elongated body portion 556 in the stored position. For example, the stop portion 580 can prevent the elongated body portion 556 from pivoting too far into the interior space 506. The stop portion 580 can be configured in a variety of ways. In some implementations, the stop portion 580 may include a cross member 584 extending traverse to the longitudinal axis X2 of the elongated body portion 556. In the stored position, the cross member 184 may abut the proximal end portion 558 of the elongated body portion 556 to prevent the elongated body portion 556 from pivoting too far into the interior space 506.

In the second position, at least a portion of the distribution point 500 may be exterior to the interior space 506, as shown in FIG. 21. In some implementations, the entire distribution point 500 is exterior to the interior space 506 in the second position.

The second mounting portion 552 may be configured to move the distribution point 500 between the second position and a third position which is more distal to the base portion 502 than the second position, as shown in FIG. 25. The second mounting portion 552 can be configured in a variety of ways. In some implementations, the second mounting portion 552 may include a translating portion or translating portion 590 arranged on the elongated body portion 556 and an attachment portion or attachment member 592 associated with the distribution point 500 that is configured to be releasably attached to the translating portion 590.

The translating portion 590 may be structurally configured to move axially along the elongated body portion 556 between the proximal end portion 558 (e.g., the second position of the distribution point 500) and the distal end portion 560 (e.g., the third position of the distribution point 500). The translating portion 590 can be configured in a variety of ways. In some implementations, the translating portion 590 may include a base portion 591 (e.g., a plate, support, or housing) and a translation assist portion 593 (e.g., one or more linear bearings) supported by the base portion 591. In some implementations, the translation assist portion 593 may reduce friction between the translating portion 590 and the elongated body portion 556 when the translating portion 590 moves relative to the elongated body portion 556 and maintain the correct position of the translating portion 590 relative to the elongated body portion 556. In some implementations, the translation assist portion 593 may include a pair of linear bearings each configured to encircle and move along a corresponding cylindrical rod of the elongated body portion 556.

Referring to FIG. 26, the attachment portion 592 may be configured in a variety of ways, such as a bracket, link, connector, hook, or other suitable mechanical coupling. In some embodiments, the attachment portion 592 may include a bracket 594 having a pair of arms 596 extending from the bracket 594. The arms 596 may be structurally configured to attach onto the translating portion 590.

In some implementations, the second mounting portion 552 may be configured to lock the attachment portion 592 to the translating portion 590, thereby locking the distribution point 500 to the enclosure 501. The attachment portion 592 can lock to the translating member 190 in a variety of ways. In the illustrated implementation, the second mounting portion 552 may include a second locking portion or second locking mechanism 600, as shown in FIGS. 23-24 and 26. The second locking portion 600 may include one or more spring-loaded pins or plungers 604. In some implementations, the second locking portion 600 may include two spring-loaded pins or plungers 604 positioned on opposite sides of the translating portion 590.

In some embodiments, each of the arms 596 may include an aperture 606 and a slot 608. The slot 608 may be configured to slide onto the translating portion 590 to support the bracket 594, and distribution point 500, onto the translating portion 590. When properly attached, each aperture 606 may align with a corresponding one of the spring-loaded pins or plungers 604 which may be received through the aperture 606 to lock the bracket 594 to the translating portion 590.

In some implementations, the second mounting portion 552 may be configured to lock the translating portion 590 at various positions along the elongated body portion 556. Thus, the distribution point 500 may be locked at various positions along the elongated body portion 556, such as in second position, in the third position, and/or in one or more intermediate positions between the second position and the third position. The second mounting portion 552 may be configured to lock the translating portion 590 at various positions along the elongated body portion 556 in a variety of ways.

In some implementations, the second mounting portion 552 may include a third locking portion or third locking mechanism 610. The third locking portion or third locking mechanism 610 may be configured in a variety of ways. For example, in some embodiments the third locking portion 610 may include one or more spring-loaded pins or plungers 612. In some embodiments, when the translating portion 590 is positioned such that the pin 612 aligns with one of the plurality of apertures (not shown), the pin 612 may be received within the aperture to lock the translating portion 590 relative to the elongated body portion 556, thus locking the position of the distribution point 500 relative to the elongated body portion 556.

In some implementations, the fiber distribution point system 490 may include a first support portion or storage support portion 613 (FIG. 20) for supporting the distribution point 500 when the distribution point is in the first or stored position and a second support portion or extension support portion 614 (FIG. 22) for supporting the distribution point 500 when the distribution point 500 is in the second and third position. The first support portion 613 may be configured in a variety of ways. In some implementations, the first support portion 613 may include structure configured to support the weight of the distribution point 500 at or near the distal end portion 532 of the distribution point 500. In some implementations, the first support portion 613 may include a platform portion 615 structurally configured to engage the distribution point 500 at or near the distal end portion 532 and an attachment portion 616 structurally configured to attach the platform portion 615 to a side wall (e.g., the fourth side wall 516) of the base portion 502 (FIG. 25).

The second support portion 614 may be configured in a variety of ways. In some implementations, the second support portion 614 may be structurally configured to support the distal end portion 560 of the elongated body portion 556 in the second and third position. In some implementations, the second support portion 614 may include an elongated body portion 618 (e.g., an arm, a shaft, a tube, a rod, a bar, etc.) having a proximal end portion 620 and a distal end portion 622 opposite the proximal end portion 620.

In some embodiments, the elongated body portion 618 may be structurally configured to move between a stored position in which the elongated body portion 618 may be received within the interior space 506 of the base portion 502 (FIG. 20) and an extended position in which at least a portion of the elongated body portion 618 may extend from the interior space 506 (FIGS. 22 & 25). The elongated body portion 618 may be configured to move between the stored position and the extended position in a variety of ways. In some implementations, the elongated body portion 618 may be configured to pivot between the stored position and the extended position.

For example, in some embodiments, the proximal end portion 620 may be pivotably attached to the base portion 502. To move from the stored position to the extended position, the elongated body portion 618 may pivot upward, as shown by arrow P, such that the elongated body portion 618 extends in the direction of the longitudinal axis X2 (e.g., parallel to the longitudinal axis X2). To provide space for the elongated body portion 618 to pivot upward and be positioned adjacent the elongated body portion 556, both of the pivot points for the elongated body portions 556, 618 may be offset from a centerline CL (FIG. 21)(e.g., closer to the first side wall 510 than to the second side wall 512).

In some implementations, the distal end portion 622 is structurally configured to attach to the distal end portion 560 of the elongated body portion 556 to support the distal end portion 560 and the distribution point 500 attached to the elongated body portion 556. The distal end portion 622 may attach to the distal end portion 560 of the elongated body portion 556 is a variety of ways. In some embodiments, the second support portion 614 may include a linking portion 624 structurally configured to fix the distal end portion 622 relative to the distal end portion 560 of the elongated body portion 556.

In some implementations, the linking portion 624 may include a rigid link 626 attached at one end, by one or more fasteners 628, to the distal end portion 622 and at the other end, by one or more fasteners 628, to the distal end portion 560 of the elongated body portion 556.

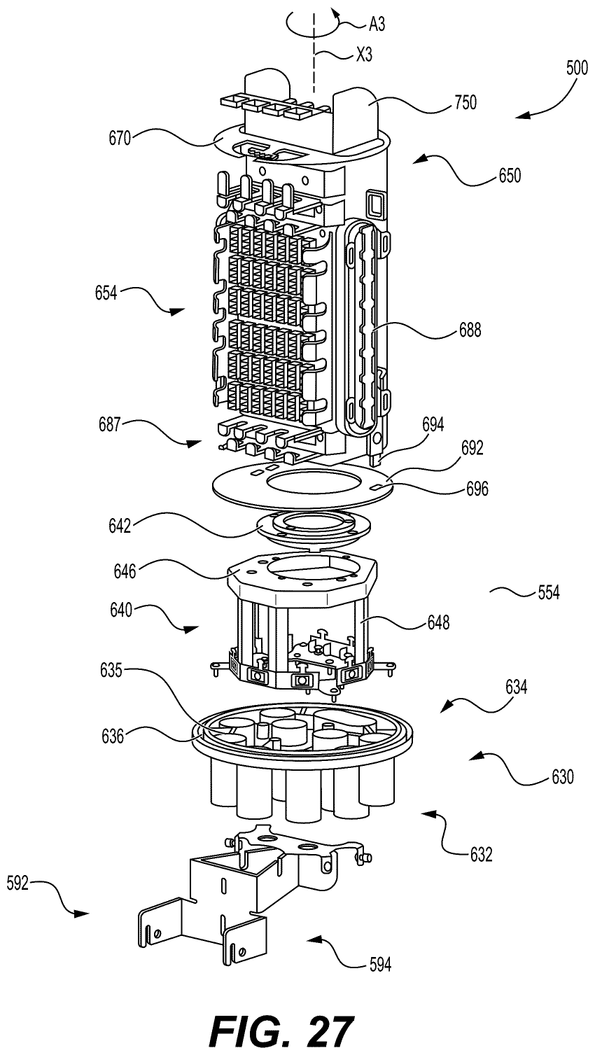

Referring to FIGS. 27-29, the distribution point 500 is illustrated with the external cover 534 removed. In some implementations, the fiber distribution point system 490 may include an end cap 630. The end cap 630 may, in some implementations, be configured to attach to the attachment portion 592 to attach the distribution point 500 to the enclosure 501. The end cap 630 can be configured in a variety of ways. In some implementations, the end cap 630 may be generally disc-shaped having a proximal end portion 632 and a distal end portion 634 opposite the proximal end portion 632. The end cap 630 may include one or more passages 635 that extend through the end cap 630 from the proximal end 632 to the distal end portion 634 for routing cable.

In some implementations, the end cap 630 may be configured to include a cover mounting portion 636 (e.g., an annular groove on the distal end portion 634) for attaching to and supporting the external cover 534 over the distribution point 500. In addition, in some implementations, the end cap 630 may be configured to support the distribution point 500. In some implementations, the distribution point 500 may be mounted to the end cap 630 by the third mounting portion 554.

The third mounting portion 554 may be configured to allow rotation of the distribution point 500 about an axis of rotation X3 relative to the enclosure 501, as shown by arrow A3 in FIG. 27. The third mounting portion 554 may be configured in a variety of ways. In some implementations, the third mounting portion 554 may include a base or base portion 640 and a rotational portion or rotational element 642. In some implementations, the base portion 640 may attach to the distal end portion 634 of the end cap 630 and may be configured to mount the rotational element 642. In some implementations, the base portion 640 may include a platform 646 spaced apart from the distal end portion 634 of the end cap 630 and supported by a plurality of legs 648.

The rotational element 642 may be configured to engage the distribution point 500 to allow rotation of the distribution point 500 relative to the base portion 640. The rotational element 642 can be configured in a variety of ways, such as for example, any suitable bearing. In some implementations, the rotational element 642 may mount onto the platform 646 between the platform 646 and the distribution point 500.

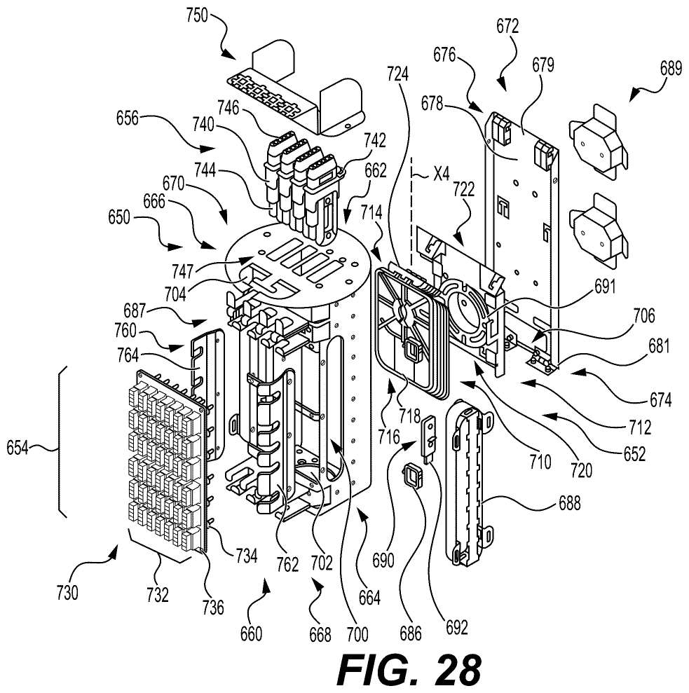

Referring to FIGS. 27-28, the distribution point 500 may be configured to provide a high-density assembly (i.e., high number of fibers, such as 144F or more) in a compact space (e.g., the internal volume of the external cover 534) while providing splicing, splitting, and patching capabilities. The distribution point 500 can be configured in a variety of ways. In some implementations, the distribution point 500 may include a frame portion 650, a splicing portion 652, a patching portion 654, and a splitting portion 656.

The frame portion 650 may be configured to support the splicing portion 652, the patching portion 654, and the splitting portion 656. The frame portion 650 can be configured in a variety of ways. In some implementations, the frame portion 650 may be generally cuboid-shaped having a front side portion 660, a back side portion 662 opposite the front side portion 660, a first lateral side portion 664 extending between the front side portion 660 and the back side portion 662, a second lateral side portion 666 opposite the first lateral side portion 664 and extending between the front side portion 660 and the back side portion 662, a bottom side portion 668 extending between the front side portion 660 and the back side portion 662, and a top side portion 670 opposite the bottom side portion 668 and extending between the front side portion 660 and the back side portion 662.

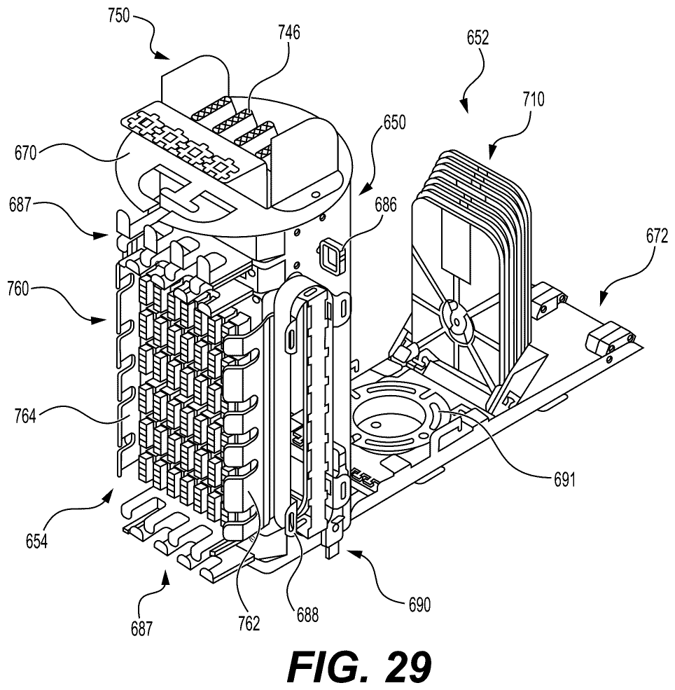

In some implementations, the back side portion 662 may include a panel portion 672. The panel portion 672 may include a bottom portion 674, a top portion 676, an inner face 678 extending between the bottom portion 674 and the top portion 676, and an outer face 679. In some implementations, the panel portion 672 may be configured to pivot away relative to the bottom portion 674. For example, in some implementations, the bottom portion 674 of the panel portion 672 may be connected to the frame portion 650 at or near the bottom side portion 668 by a pivot connection 681 (e.g., one or more hinges) such that the top portion 676 of the panel portion 672 may pivot outward, as shown in FIG. 29.

In some implementations, the distribution point 500 may include a cable management portion. In some implementations, the cable management portion may include a first cable routing portion 686 (e.g., one or more cable clips) structurally configured to guide or route cable associated with the distribution point 500. The first cable routing portion 686 may be configured in a variety of ways. In some implementations, the first cable routing portion 686 may include one or more cable clips configured to route cable associated with the distribution point 500 along the first lateral side portion 664 and/or the second lateral side portion 666.

In some implementations, the cable management portion may include a second cable routing portion 687 structurally configured to guide or route cable associated with the distribution point 500. The second cable routing portion 687 may be configured in a variety of ways. In some implementations, the second cable routing portion 687 may include one or more horizontal cable managers configured to route cable associated with the distribution point 500 along the front side portion 660. In some implementations, the second cable routing portion 687 may include a pair of spaced apart horizontal cable managers positioned on the front side portion 660.

In some implementations, the cable management portion may include a first slack cable storage portion 688 (e.g., one or more cable spools) structurally configured to store or retain an excess length of cable associated with distribution point 500 (e.g., by winding the excess length around a spool or spindle). In some implementations, the first slack cable storage portion 688 may be mounted at the first lateral side portion 664 and/or the second lateral side portion 666.

In some implementations, the cable management portion may include a second slack cable storage portion 689 (e.g., one or more cable spools) structurally configured to store or retain an excess length of cable associated with distribution point 500 (e.g., by winding the excess length around a spool or spindle). In some implementations, the second slack cable storage portion 689 may be mounted on the outer face 679 of the panel portion 672.

In some implementations, the cable management portion may include a third slack cable storage portion 691 (e.g., one or more cable spools) structurally configured to store or retain an excess length of cable associated with distribution point 500 (e.g., by winding the excess length around a spool or spindle). In some implementations, the third slack cable storage portion 691 may be mounted on the splice holder base 712.

In some implementations, the fiber distribution point system 490 may include a fourth locking portion or fourth locking portion 690 (FIG. 13) configured to lock the distribution point 500 at various degrees of rotation about the axis of rotation X3. The fourth locking portion 690 can include any suitable locking mechanism, such as a mechanical lock, for example. In some implementations, the fourth locking portion 690 may include a base portion 692 and a spring latching portion 694. In some implementations, the base portion 692 may be fixed to the base portion 640 (e.g., onto the platform 646) and thus stationary relative to rotation of the distribution point 500. In the illustrated implementation, the base portion 692 is annular and includes one or more apertures 696 (FIG. 27).

The spring latching portion 694 may be attached to the distribution point 500 for rotation therewith. In some implementations, the spring latching portion 694 may be mounted onto the first lateral side portion 664 adjacent the bottom side portion 668 of the frame portion 650. The distribution point 500 may be locked in place rotationally at various degrees of rotation about the axis X3 where one or more apertures 696 aligns with the spring latching portion 694 such that the spring latching portion 694 can be received in one of the apertures 696.

In some implementations, the frame portion 650 may include one or more apertures configured to route cable therethrough. For example, in some implementations, the first lateral side portion 664 and/or the second lateral side portion 666 may include one or more first routing apertures 700 configured to route cable through the corresponding first lateral side portion 664 and second lateral side portion 666. In some embodiments, the bottom side portion 668 may include one or more second routing apertures 702 configured to route cable through bottom side portion 668 and the top side portion 670 may include one or more third routing apertures 704 configured to route cable through top side portion 670. In some embodiments, the panel portion 672 may include one or more fourth routing apertures 706 configured to route cable through the panel portion 672.

In some implementations, top side portion 670 may be configured to guide the external cover 534 onto and off of the distribution point 500. In some implementations, top side portion 670 may have a shape that is complementary to a shape of the hollow interior of the external cover 534. For example, in some implementations, the top side portion 670 may be disc-shaped where the external cover 534 has a circular cross-section shaped hollow interior.

Referring to FIGS. 29-29, the splicing portion 652 may be configured to mount a plurality of spliced together fiber cables. The splicing portion 652 can be configured in a variety of ways. In some implementations, the splicing portion 652 may include a plurality of splice holders 710 and a splice holder base 712. The splice holders 710 can be configured in a variety of ways. In some implementations, each splice holder 710 may be configured as a tray or card having a proximal end 714, a distal end 716, a longitudinal axis X4, and a fiber retaining portion 718. The fiber retaining portion 718 may be configured to hold a plurality of pairs of spliced together fibers in a parallel, spaced-apart orientation. The number of pairs of spliced together fibers each splice holder 710 can hold may vary in different implementations. In some implementations, each splice holder 710 may hold 18-30 pairs of spliced together fibers, or 20-28 spliced together fibers, or 24 spliced together fibers.

The splice holder base 712 may be configured to support the plurality of splice holders 710. The splice holder base 712 can be configured in a variety of ways. In some implementations, the splice holder base 712 may include a first portion 720 configured to attach to the inner face 678 of the panel portion 672 and a second portion 722 configured to mount the splice holders 710. The number of splice holders 710 that the splice holder base 712 can support may vary in different implementations. In some implementations, the splice holder base 712 may be configured to support 6-10 splice holders 710, or 8 slice holders 710.

In some implementations, the splice holders 710 may be configured to pivot relative to the splice holder base 712. For example, each splice holder 710 may be connected to the splice holder base 712 by a pivot connection 724. In some implementations, the proximal end 714 of each splice holder 710 may be connected to the splice holder base 712 via the pivot connection 724 located on the second portion 722 of the splice holder 710. In some implementations, the second portion 722 may extend outward from the first portion 720 at an angle (e.g., 15-45 degrees). In some embodiments, the splice holder base 712 may be configured to mount the splice holders 710 in a stacked arrangement.

In some implementations, the splice holders 710 may be configured to pivot from a first position (e.g., a stored or closed position), as shown in the exploded view of FIG. 28 to a second position (e.g., an open position where the splice holders are more accessible for a technician to work on) as shown in FIG. 29. In some implementations, in the first position, the longitudinal axis X4 of each of the splice holders 710 may be oriented generally parallel (e.g., ±10 degrees) to the first portion 720 of the splice holder base 712 and/or generally parallel (e.g., ±10 degrees) to the inner face 678 of the panel portion 672. In some implementations, in the second position, the longitudinal axis X4 of each of the splice holders 710 may be oriented generally perpendicular (e.g., 80-100 degrees) to the first portion 720 of the splice holder base 712 and/or generally perpendicular (e.g., 80-100 degrees) to the inner face 678 of the panel portion 672.

The patching portion 654 may be configured as the fiber input and fiber output portion of the distribution point 500. For example, in some implementations, the patching portion 654 may include a plurality of input ports 730 configured to receive and arrange fibers coming into the distribution point 500 and a plurality of output ports 732 configured to receive and arrange fibers outgoing from the distribution point 500. The patching portion 654 can be configured in a variety of ways.

In some implementations, the patching portion 654 may include a plurality of input ports 730 and a plurality of output ports 732 arranged on a base 734 (e.g., substrate, panel, board, etc.). In some implementations, the plurality of input ports 730 may be arranged in one or more columns and the plurality of output ports 732 may be arranged in one or more separate columns. In some implementations, a plurality of the output ports 732 may be arranged on an adapter or module 736 and multiple adapters or modules can be utilized in the patching portion 654. In some implementations, patching portion 654 may be attached to the front side portion 660 of the frame portion 650.

The patching portion 654 may be configured similar to the patching portion 244 of FIGS. 13-15. In the illustrated implementation, however, the patching portion 244 is separated into a first and second patching arrangement 314, 316 by cable management portion 324 while the patching portion 654 is not split. Each of the input ports 730 and the output ports 732 can be any suitable configuration. For example, in some implementations, the input ports 730 and the output ports 732 may be configured as LC connectors. The patching portion 654 may include any suitable number of input ports 730 and the output ports 732. For example, in some implementations, the patching portion 654 may have twenty-four (24) input ports 730 and one hundred forty-four (144) output ports.

The splitting portion 656 may be configured to receive a fiber cable or fibers as input and split the fiber cable or fibers into multiple outputs. The splitting portion 656 can be configured in a variety of ways. In some implementations, the splitting portion 656 may include a plurality of fiber splitters 740. The number and arrangement of fiber splitters 740 may vary in different implementations. In some implementations, the splitting portion 656 includes a plurality of fiber splitters 740 arranged side-by-side in a row on a base 742 (e.g., substrate, panel, board, etc.). In some implementations, the splitting portion 656 may include four fiber splitters 740 arranged side-by-side.

Each fiber splitter 740 can be configured in a variety of ways, including the number of input ports and the number of output ports per fiber splitter. In some implementations, each fiber splitter 740 includes one or more splitter input ports 744 and a plurality of splitter output ports 746 (FIG. 28). In some implementations, each fiber splitter 740 may include a single splitter input port 744 and thirty-two splitter output ports 746. Thus, in some implementations, the splitting portion 656 may include four splitter input ports 744 and one hundred twenty-eight (128) splitter output ports 746.

In some implementations, the top side portion 670 may be structurally configured to mount the splitting portion 656. For example, in some implementations, the top side portion 670 may include a splitter receiving portion 747 (e.g., one or more openings) structurally configured to receive and mount the splitting portion 656. In some implementations, the distribution point 500 may include a splitter protection portion 750 configured to protect the splitting portion 656 mounted in the top side portion 670. The splitter protection portion 750 may be configured in a variety of ways.

In some implementations, the splitter protection portion 750 may include one or more walls extending from the top side portion 670 that at least partially surround the splitting portion 656. For example, in some implementations, the splitter protection portion 750 may include a first lateral side wall portion 752, a second lateral side wall portion 754 opposite the first lateral side wall 752, and a front wall portion 756 extending between the first and second lateral side wall portions 752, 754. In some implementations, the first and second lateral side wall portions 752, 754, and the front wall portion 756 may form a U-shape. In some implementations, the first lateral side wall portion 752 may be parallel to the second lateral side wall portion 754.

In some implementations, the distribution point 500 may include a patching protection portion 760 configured to protect the patching portion 654 mounted in the front side portion 660. The patching protection portion 760 may be configured in a variety of ways. In some implementations, the patching protection portion 760 may include one or more walls extending from the front side portion 660 that at least partially surround the patching portion 654. For example, in some implementations, the patching protection portion 760 may include a first lateral side wall portion 762 and a second lateral side wall portion 764 positioned opposite the first lateral side wall portion 762. In some implementations, the first and second lateral side wall portions 762, 764 may bracket the patching portion 654 therebetween.

In some implementations, the distribution point 500 may be configured to provide one or more cable routing options. For example, in some implementations, the distribution point 500 may include one or more operative routing options in which one or more of the splicing portion 652, the patching portion 654, and the splitting portion 656 may be utilized. For example, in some implementations, the distribution point 500 may be configured such that an input fiber optic cable (not shown) may be received into the distribution point 500 through the one or more apertures 702 in the bottom side portion 668, may be routed to the third slack cable storage portion 691 on the splice holder base 712 where excess length may be stored, and then may terminate at the splice holders 710. From the splice holders 710, pigtails (not shown) may be routed to the third slack cable storage portion 691 in the splice holder base 712 where excess length may be stored, and then may enter the back side of the patching portion 654. Connectorized lines (not shown) connect to the fibers via the front of the patching portion 654 and may be routed to one of the first slack cable storage portions 688 (e.g., at the first lateral side portion 664) where excess length may be stored, and then routed to the splitting portion 656.

As mentioned above, in some implementations, the splitting portion 656 may split each single input into thirty-two splitter outputs. The outputs of the splitting portion 656 may be routed to one of the first slack cable storage portions 688 (e.g., at the second lateral side portion 666) where excess length may be stored, and then routed into the front side of the patching portion 654. Pigtails may connect to the fibers via the backside of the patching portion, and may be routed to the third slack cable storage portion 691 where excess length may be stored, and then to the splice holders 710. Output from the splice holders 710 may then be routed to exit the distribution point 500.

In some implementations, the distribution point 500 may be configured to provide a pass-through routing option in which fiber optic cable (not shown) may enter and pass through the distribution point without any, or only a portion, of the fibers from the fiber optic cable acted upon by the splicing portion 652, the patching portion 654, and the splitting portion 656. For example, in some implementations, the fiber optic cable may enter the aperture 702 in the bottom side portion 668 of the frame portion 650, may be routed out of the aperture 706 in the panel portion 672 where excess length of the fiber optic cable may be stored by the second slack cable storage portion 689 on the outer face 679 of the panel portion 672. From the second slack cable storage portion 689, the fiber optic cable may be routed back through the aperture 706 in the panel portion 672 and out of the aperture 702 in the bottom side portion 668 of the frame portion 650.

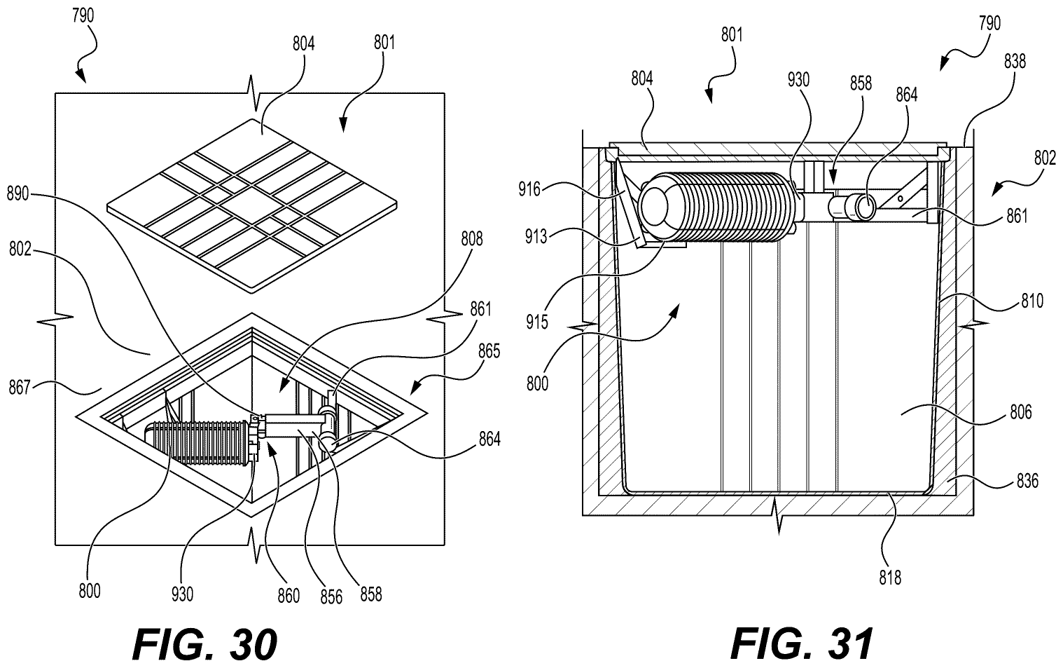

FIGS. 30-32 show an example fiber distribution point system 790, for example, a vault distribution point, in accordance with embodiments of the disclosure. The example fiber distribution point system 790 includes a fiber distribution point 800 (or fiber distribution portion) and an enclosure 801 configured to house the distribution point 800. The enclosure 801 has, in this example, a base or base portion 802 and a cover or cover portion 804.

In some implementations, the base portion 802 and the fiber distribution point 800 may be substantially similar to the base portion 502 and fiber distribution point 500 of FIGS. 19-29. Thus, the description of the base portion 502 and the fiber distribution point 500 applies equally to the base portion 802 and the fiber distribution point 800. The base portion 802 may define an interior space 806 and an opening 808 to the interior space 806 and a cover 804 may be configured to be received at the opening 808 to cover the interior space 806.

In some implementations, the base portion 802 may include a plurality of side walls 810 (e.g., four side walls similar to the side walls 510, 512, 514, 516) and a bottom wall 818 extending between the side walls 810. In some implementations, the base portion 802 may be generally cuboid-shaped.

The interior space 806 may be configured to house the distribution point 800. As shown in FIG. 31, the interior space 806 may be sized such that the distribution point 800 can be positioned entirely within the interior space 806 in a first position (i.e., a fully stored position). In some implementations, the base portion 802 may be configured to be installed within a cavity or recess 836 in a floor or a ground surface 838. Thus, in some implementations, the enclosure 801 may provide a compact, covered, underground location to house the distribution point 800.

The enclosure 801 may be configured to move the distribution point 800 between the first position (i.e., the stored position) to one or more other positions that provide better access for a technician to work on the distribution point 800. The system 790 may be configured to move the distribution point 800 between the first position (i.e., the stored position) to one or more other positions in a variety of ways. For example, in some implementations the enclosure 801 may include one or more mounting portions structurally configured to move the distribution point 800.

In some implementations, the enclosure 801 may include a first mounting portion 850, a second mounting portion 852, and a third mounting portion (not shown). The first mounting portion 850 may be structurally configured to move the fiber distribution point 800 between the first position where the distribution point 800 is received within the interior space 806 and a second position in which the distribution point 800 is exterior or at least partially exterior, to the interior space 806. The first mounting portion 850 can be configured in a variety of ways.

In some embodiments, the first mounting portion 850 may have an elongated body portion 856 (e.g., an arm, a shaft, a tube, a rod, a bar, etc.) having a proximal end portion 858 connected to the base portion 802 and a distal end portion 860 opposite the proximal end portion 858. In some implementations, the elongated body portion 856 may have a rectangular cross-sectional shape. In other implementations, however, the elongated body portion 856 can have a cross-sectional shape other than rectangular (e.g., round, oval, diamond, triangular, square, etc.).

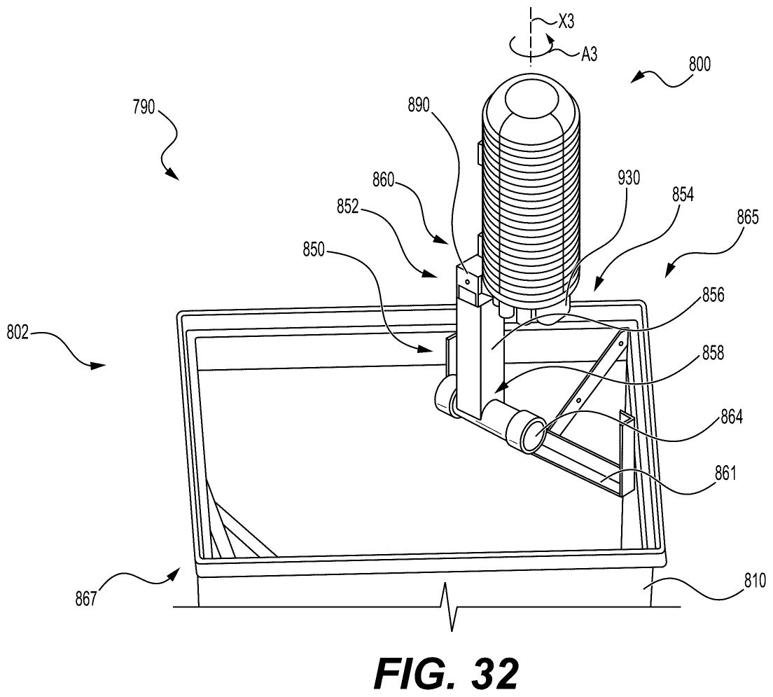

In some implementations, the proximal end portion 858 may be structurally configured to connect to the base portion 802 via a connection that is structurally configured to pivot the distribution point 800 from the first position, as shown in FIGS. 30-31, to the second position, as shown in FIG. 32. In some implementations, when the distribution point 800 is in the first position, the body portion 856 may be in a stored position, such as for example, generally horizontal (e.g., ±10 degrees) or generally parallel (e.g., ±10 degrees) to the bottom wall 818 of the base portion 802. Further, in some implementations, when the distribution point 800 is in the second position, the elongated body portion 856 may be an upright position, such as for example, generally vertical (e.g., ±10 degrees) or generally perpendicular (e.g., ±10 degrees) to the bottom wall 818 of the base 802.

The proximal end portion 858 of the elongated body portion 856 may be connected to the base portion 802 in a variety of ways. Any suitable connection configured to pivot the elongated body portion 856 may be used. In some implementations, the base portion 802 may include a cross-support portion 861 extending between adjacent side walls 810.

In some implementations, the proximal end portion 858 of the elongated body portion 856 may be connected to cross-support portion 861 by a pivot pin connection 864 about which the elongated body portion 856 may pivot. In some implementations, the elongated body portion 556 may be configured to pivot 90±15 degrees, or 90 degrees.

In some implementations, the cross-support portion 861 and the pivot pin connection 864 may be structurally configured to mount the elongated body portion 856 and distribution point 800 such that the elongated body portion 856 extends from a first corner 865 toward a second opposite corner 867 of the base portion 802 opposite of the first corner 865 from where the cross-support portion 861 is mounted (e.g., extends along a diagonal). For example, in some implementations, where the base portion 802 has a generally square cross-sectional shape, the elongated body portion 856 may extend at an angle, relative to one of the side walls 810 forming the first corner 865, of 45±5 degrees. Thus, the support portion 861 and the pivot pin connection 864 may be structurally configured to mount the elongated body portion 856 and distribution point 800 along the widest portion of the base portion 802 or opening 808.

In some implementations, the first mounting portion 850 may be configured to lock in the upright position. The first mounting portion 850 can be configured to lock in the upright position in a variety of ways, such as any locking portion described herein or any suitable locking portion. In the second position, at least a portion of the distribution point 800 may be exterior to the interior space 806, as shown in FIG. 32. In some implementations, the entire distribution point 800 is exterior to the interior space 806 in the second position.

In some implementations, the second mounting portion 852 may be configured to attach the distribution point 800 to the distal end portion 860 of the elongated body portion 856. Since the support portion 861 and the pivot pin connection 864 may be structurally configured to mount the elongated body portion 856 and distribution point 800 along the widest portion of the base portion 802 or opening 808, in some implementations, the distribution point 800 may be stored in the first or stored position in an extended position relative to the elongated body portion 856 (e.g., at the distal end portion 860). Thus, in some implementations, the distribution point 800 may not need to be extended (e.g., via translating portion 590) after pivoting out of the base portion 802 since the distribution point 800 is stored within the interior space 806 in an extended position relative to the elongated body portion 856.

The second mounting portion 852 can be configured in a variety of ways. In some implementations, the second mounting portion 852 may include a bracket portion 890 fixed to the distal end portion 860 and an attachment portion or attachment member 892 associated with the distribution point 800 that is configured to be releasably attached to the bracket portion 890.

Referring to FIG. 26, the second mounting portion 852 may be configured in a variety of ways, such as one or more brackets, links, connectors, hooks, fasteners, or other suitable mechanical couplings, including any mounting portions disclosed herein suitable for connecting the distribution point 800 to the elongated body portion 856.

In some implementations, the fiber distribution point system 790 may include a first support portion 913 (FIG. 31) for supporting the distribution point 800 when the distribution point is in the first or stored position. The first support portion 913 may be configured in a variety of ways, such as for example, the same or similar to the first support portion 613 of FIGS. 20-21. In some implementations, the first support portion 913 may include structure configured to support the weight of the distribution point 800 at or near the distal end portion 832 of the distribution point 800. In some implementations, the first support portion 913 may include a platform portion 915 structurally configured to engage the distribution point 800 at or near the distal end portion 832 and an attachment portion 916 structurally configured to attach the platform portion 915 to a side wall 810 of the base portion 802 (FIG. 31).

The distribution point 800 may be configured the same or substantially similar to the distribution points 100, 500 described herein. Thus, the description of distribution points 100, 500 apply equally to the distribution point 800. In some implementations, the system 790 may include an end cap 930, which may be similar to, for example, end cap 630. The end cap 930 may, in some implementations, be configured to attach the distribution point 800 to the enclosure 801.

The third mounting portion (not shown) may be configured to allow rotation of the distribution point 800 about an axis of rotation X3 relative to the enclosure 801, as shown by arrow A3 in FIG. 32. The third mounting portion (not shown) may be structurally configured the same or similar to the third mounting portions 154, 554; thus the description of the third mounting portions 154, 554 applies equally to the third mounting portion of the system 790.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A fiber distribution point structurally configured to minimize an interior space of a closure required to receive the fiber distribution point and to provide enhanced access to the fiber distribution point, comprising:
a fiber management portion structurally configured to include a splicing portion, a patching portion, and a splitting portion;
a first mounting portion structurally configured to pivotally couple the fiber management portion with a closure;
a second mounting portion structurally configured to slidingly couple the fiber management portion with the first mounting portion;
a third mounting portion structurally configured to rotatingly couple the fiber management portion with the second mounting portion;
wherein the first mounting portion includes a body portion that is structurally configured to pivot the fiber management portion between a first position and a second position;
wherein the first mounting portion includes a first locking portion that is structurally configured to lock the body portion in the second position;
wherein the second mounting portion includes a translating portion that is structurally configured to move axially along a length of the body portion to move the fiber management portion between the second position, which is proximal to a pivot axis of the body portion, and a third position, which is distal from the pivot axis;
wherein the second mounting portion includes a second locking portion that is structurally configured to releasingly couple the translation portion to the body portion;
wherein the fiber distribution point includes a first support portion structurally configured to support the fiber management portion in the first position by engaging a distal end portion of the fiber management portion;
wherein the fiber distribution point includes a second support portion structurally configured to support the fiber management portion in the third position by engaging a distal end portion of the first mounting portion, wherein the second support portion is configured to pivot between a stored position in which second support portion is configured to be received within an interior space of the closure and an extended position, where the second support portion extends out of the interior space;
wherein the fiber management portion is structurally configured to be rotatingly coupled with an attachment portion of the third mounting portion;
wherein the third mounting portion includes a third locking mechanism that is structurally configured to couple the attachment portion with the second mounting portion;
wherein the third mounting portion is structurally configured to allow rotation of the fiber management portion about an axis of rotation;
wherein the fiber management portion includes a fourth locking mechanism that is structurally configured to lock the fiber management portion at various degrees of rotation about the axis of rotation;
wherein the second mounting portion includes a translating portion that is structurally configured to slidingly move relative to the body portion along a length of the body portion;
wherein the body portion is structurally configured to be disposed at the first position such that the fiber distribution point is structurally configured to minimize an interior space of a closure required to receive the fiber distribution point so as to reduce a ground level footprint of the closure; and
wherein the first mounting portion, the second mounting portion, and the third mounting portion are structurally configured to move the fiber distribution point relative to the closure so as to provide enhanced access to the splicing portion, the patching portion, and the splitting portion.

2. The fiber distribution point of claim 1, wherein the closure has an internal volume of less than 30,000 cm³.

3. The fiber distribution point of claim 1, wherein the patching portion has 144 or more fiber output ports.

4. The fiber distribution point of claim 1, wherein the splitting portion is configured to provide 128 splitter output ports.

5. The fiber distribution point of claim 1, wherein the fiber management portion includes a frame portion that is structurally configured to support the splicing portion, the patching portion, and the splitting portion, the frame portion including a front side portion and a rear side portion, and wherein the rear side portion includes a panel portion structurally configured to pivot outward.

6. The fiber distribution point of claim 1, wherein the splicing portion is structurally configured to attach to an inner face of the panel portion, the splicing portion including a splice holder portion structurally configured to pivot relative to the splice holder base portion.

7. The fiber distribution point of claim 1 wherein the fiber management portion is structurally configured to provide a pass-through route for a communication cable to be routed through the fiber management portion without interacting with the splicing portion, patching portion, or splitting portion, and wherein the pass-through route includes a cable management portion attached to an outer face of the panel portion.

8. A fiber distribution point structurally configured to minimize an interior space of a closure required to receive the fiber distribution point and to provide enhanced access to the fiber distribution point, comprising:
a fiber management portion;
a first mounting portion having a body portion structurally configured to couple the fiber management portion with a closure and to pivot the fiber management portion between a first position and a second position;
a second mounting portion having a translating portion structurally configured to couple the fiber management portion with the first mounting portion and to move axially along a length of the body portion to move the fiber management portion between the second position which is proximal to a pivot axis of the body portion and a third position which is distal from the pivot axis;
a third mounting portion structurally configured to couple the fiber management portion with the second mounting portion and allow rotation of the fiber management portion about an axis of rotation;
a support portion structurally configured to support the fiber management portion in the first position by engaging a distal end portion of the fiber management portion and to support the fiber management portion in the third position by engaging a distal end portion of the first mounting portion;
wherein the body portion is structurally configured to be disposed at the first position such that the fiber distribution point is structurally configured to minimize an interior space of a closure required to receive the fiber distribution point so as to reduce a ground level footprint of the closure; and
wherein the first mounting portion, the second mounting portion, and the third mounting portion are structurally configured to move the fiber distribution point relative to the closure so as to provide enhanced access to the fiber management portion.

9. The fiber distribution point according to claim 8, wherein the first mounting portion includes a first locking portion that is structurally configured to lock the body portion in the second position.

10. The fiber distribution point according to claim 9, wherein the second mounting portion includes a second locking portion that is structurally configured to releasingly couple the translation portion to the body portion.

11. The fiber distribution point according to claim 8, wherein the fiber management portion is structurally configured to be rotatingly coupled with an attachment portion of the third mounting portion and wherein the third mounting portion includes a third locking mechanism that is structurally configured to couple the attachment portion with the second mounting portion.

12. The fiber distribution point according to claim 8, wherein the fiber management portion includes a splicing portion, a patching portion, a splitting portion, and a frame portion that is structurally configured to support the splicing portion, the patching portion, and the splitting portion, wherein the patching portion is structurally configured to attach to a front side of the frame portion and the splitting portion is structurally configured to attach to a top side of the frame portion.

13. The fiber distribution point according to claim 12, wherein the fiber management portion is structurally configured to provide a pass-through route for a communication cable to be routed through the fiber management portion without interacting with the splicing portion, patching portion, or splitting portion, wherein the pass-through route includes a cable management portion attached to an outer face of the panel portion.

14. The fiber distribution point according to claim 8, wherein the support portion comprises a first support portion and a second support portion, wherein the second support portion is structurally configured to support the fiber management portion in the third position by engaging a distal end portion of the first mounting portion, wherein the second support portion is structurally configured to pivot between a stored position in which second support portion is configured to be received within an interior space of the closure and an extended position, where the second support portion extends out of the interior space.

15. The fiber distribution point according to claim 8, wherein the fiber management portion includes a rotation locking mechanism that is structurally configured to lock the fiber management portion at various degrees of rotation about the axis of rotation.

16. A fiber distribution point structurally configured to minimize an interior space of a closure required to receive the fiber distribution point and to provide enhanced access to the fiber distribution point, comprising:
a fiber management portion;
a mounting portion having a body portion structurally configured to couple the fiber management portion with a closure and to pivot the fiber management portion between a first position and a second position and a translating portion structurally configured to move axially along a length of the body portion to move the fiber management portion between the second position, which is proximal to a pivot axis of the body portion, and a third position, which is distal from the pivot axis;
wherein the mounting portion is structurally configured to allow rotation of the fiber management portion about an axis of rotation;
wherein the body portion is structurally configured to be disposed at the first position such that the fiber distribution point is structurally configured to minimize an interior space of a closure required to receive the fiber distribution point so as to reduce a ground level footprint of the closure; and
wherein the mounting portion is structurally configured to move the fiber distribution point relative to the closure so as to provide enhanced access to the fiber management portion.

17. The fiber distribution point according to claim 16, wherein the fiber management portion includes a splicing portion, a patching portion, a splitting portion, and a frame portion structurally configured support the splicing portion, the patching portion, and the splitting portion.

18. The fiber distribution point according to claim 17, wherein the frame portion includes a panel portion structurally configured to pivot outward, wherein the splicing portion is structurally configured to attach to an inner face of the panel portion, wherein the splicing portion includes a splice holder structurally configured to attach to and pivot relative to a splice holder base portion.

19. The fiber distribution point according to claim 17, wherein the fiber management portion is structurally configured to provide a pass-through route for a communication cable to be routed through the fiber management portion without interacting with the splicing portion, patching portion, or splitting portion, wherein the pass-through route includes a cable management portion attached to an outer face of the panel portion.

20. The fiber distribution point according to claim 17, wherein the patching portion is configured to include 144 or more fiber output ports and the splitting portion is configured to include 128 splitter output ports.

21. The fiber distribution point according to claim 16, wherein the mounting portion includes a first mounting portion that structurally configured to couple the fiber management portion with a closure, a second mounting portion structurally configured to couple the fiber management portion with the first mounting portion, and a third mounting portion structurally configured to couple the fiber management portion with the second mounting portion.

22. The fiber distribution point according to claim 21, wherein the first mounting portion includes a first locking portion that is structurally configured to lock the body portion in the second position.

23. The fiber distribution point according to claim 22, wherein the second mounting portion includes a second locking portion that is structurally configured to releasingly couple the translation portion to the body portion.

24. The fiber distribution point according to claim 23, wherein the fiber management portion is structurally configured to be rotatingly coupled with an attachment portion of the third mounting portion and wherein the third mounting portion includes a third locking mechanism that is structurally configured to couple the attachment portion with the second mounting portion.

25. The fiber distribution point according to claim 16, wherein the fiber management portion includes a rotation locking mechanism that is structurally configured to lock the fiber management portion at various degrees of rotation about the axis of rotation.

26. The fiber distribution point according to claim 16, further comprising a storage support portion structurally configured to support the fiber management portion in the first position by engaging a distal end portion of the fiber management portion.

27. The fiber distribution point according to claim 16, further comprising an extension support portion structurally configured to support the fiber management portion in the third position by engaging a distal end portion of the first mounting portion.

28. The fiber distribution point according to claim 27, wherein the extension support portion is structurally configured to pivot between a stored position in which extension support portion is configured to be received within an interior space of the closure and an extended position, where the extension support portion extends out of the interior space.
